(19) United States
(12) Patent Application Publication
(10) Pub. No.: US 2020/0067705 A1
(43) Pub. Date: Feb. 27, 2020

(54) METHODS, APPARATUSES, AND COMPUTER PROGRAM PRODUCTS FOR FRICTIONLESS ELECTRONIC SIGNATURE MANAGEMENT

(71) Applicant: Averon US, Inc., Henderson, NV (US)

(72) Inventors: Wendell BROWN, Henderson, NV (US); Mark HERSCHBERG, Henderson, NV (US)

(21) Appl. No.: 16/549,680

(22) Filed: Aug. 23, 2019

Related U.S. Application Data
(60) Provisional application No. 62/721,946, filed on Aug. 23, 2018.

(51) Int. Cl. H04L 9/08; H04L 9/32

(52) U.S. Cl. CPC H04L 9/0866; H04L 9/3231; H04L 9/3247; H04L 9/0872

(57) ABSTRACT

Various embodiments of the present disclosure are directed to managing frictionless electronic signing of documents. In this regard, electronic document data objects may be associated with electronic signature data objects representing the electronic signature of a user verified through a third-party authentication process. Embodiments provided include an apparatus configured to receive an electronic signature request data object comprising electronic signature request information, identify device identification information associated with the signor client device, associate at least a portion of the device identification information with at least an electronic document data object to identify an associated signing information set, and store an electronic signature data object based on the associated signing information set. Other embodiments provided include an apparatus configured to generate and transmit the electronic signature request data object.

### CROSS-REFERENCE TO RELATED APPLICATIONS

This application claims priority to U.S. Provisional Application No. 62/721,946 filed Aug. 23, 2018, the content of which is incorporated herein by reference in its entirety.

### TECHNOLOGICAL FIELD

Embodiments of the present disclosure generally relate to electronically signing data such as an electronically managed document data object, and specifically, to systems, apparatuses, methods, and computer program products for frictionless electronic signature management for electronic signature management and verification.

### BACKGROUND

In various contexts, a user often wishes to provide an electronic signature for a printed or an electronically maintained document, via a user device under the control of the user. However, conventional systems, apparatuses, methods, and computer program products for obtaining an electronic signature requires a user to authenticate their identity using active registration and provisioning by the user. Additionally or alternatively, such conventional implementations often rely on the user to maintain secret information that is used to authenticate the user's identity with the conventional system. Applicant has discovered problems with current systems, methods, apparatuses, and computer program products for electronic signing, and through applied effort, ingenuity, and innovation, Applicant has solved many of these identified problems by developing a solution that is embodied in the present disclosure, which is described in detail below.

### BRIEF SUMMARY

In general, embodiments of the present disclosure provided herein include systems, methods, apparatuses and computer readable media for frictionless electronic signature management. In this regard, embodiment apparatus(es) and/or system(s) may include computer-coded instructions capable of similar operations to those performed in embodiment methods. Similarly, embodiment computer program products may include program code instructions for similar operations to those performed in embodiment methods. Other systems, apparatuses, methods, computer readable media, and features will be, or will become, apparent to one with skill in the art upon examination of the following figures and detailed description. It is intended that all such additional systems, apparatuses, methods, computer readable media, and features be included within this description be within the scope of the disclosure and be protected by the following claims.

In some example embodiments, an apparatus for frictionless electronic signature management. The apparatus comprises at least one processor and at least one memory, the at least one memory having computer-coded instructions thereon. The computer-coded instructions configured to, in execution with the at least one processor, configure the apparatus to receive, from a signor client device, an electronic signature request data object comprising electronic signature request information; identify device identification information associated with the signor client device; associate at least a portion of the device identification information with at least an electronic document data object to identify an associated signing information set; and store, to an electronic signature storage, an electronic signature data object based on the associated signing information set. In some such embodiments, the electronic signature storage comprises an electronic signature blockchain.

Alternatively or additionally, in some embodiments of the apparatus, the device identification information associated with the signor client device is identified, using a header enrichment process, from a network device associated with a trusted network provider.

Alternatively or additionally, in some embodiments of the apparatus, the apparatus is further configured to receive an electronic document request data object from the signor client device; and provide an electronic document data object associated with the electronic document request data object to the signor client device, wherein the apparatus is configured to receive the electronic signature request data object in response to user engagement with the electronic document data object on the signor client device.

Alternatively or additionally, in some embodiments of the apparatus, the electronic signature request data object further comprises device location data associated with the signor client device, and the apparatus is further configured to identify proximity data associated with the signor client device; and compare the device location data and the proximity data to determine the device location data is within a geographic region defined by the proximity data.

Alternatively or additionally, in some embodiments of the apparatus, the electronic signature request data object further comprises device user biometric data, and the apparatus is further configured to identify confirmed biometric data associated with the signor client device; and compare the device user biometric data and the confirmed biometric data to determine the device user biometric data matches the confirmed biometric data.

Alternatively or additionally, in some embodiments of the apparatus, the electronic signature request data object further comprises device location data associated with the signor client device, and the apparatus is further configured to identify proximity data associated with the signor client device; compare the device location data and the proximity data to determine the device location data is not within a geographic region defined by the proximity data; and transmit a signature denial error to the signor client device in response to the determination.

Alternatively or additionally, in some embodiments of the apparatus, the electronic signature request data object further comprises device user biometric data, and the apparatus is further configured to identify confirmed biometric data associated with the signor client device; compare the device user biometric data and the confirmed biometric data determine the device user biometric data does not match the confirmed biometric data; and transmit a signature denial error to the signor client device in response to the determination.

Alternatively or additionally, in some embodiments of the apparatus, the apparatus further configured to receive, from an authentication service, a signing continuation signal in response to authentication, by the authentications service, of the device user identity associated with the signor client device.

In some other example embodiments, a computer-implemented method for frictionless electronic signature management is provided. The computer-implemented method may be implementable using specially configured computing hardware, software, or a combination thereof, for example via a specially configured device. An example computer-implemented method includes receiving, from a signor client device, an electronic signature request data object comprising electronic signature request information; identifying device identification information associated with the signor client device; associating at least a portion of the device identification information with at least an electronic document data object to identify an associated signing information set; and storing, to an electronic signature storage, an electronic signature data object based on the associated signing information set. In some such embodiments of the computer-implemented method, the electronic signature storage comprises an electronic signature blockchain.

Alternatively or additionally, in some embodiments of the computer-implemented method, the device identification information associated with the signor client device is identified, using a header enrichment process, from a network device associated with a trusted network provider.

Alternatively or additionally, in some embodiments of the computer-implemented method, the computer-implemented method further includes receiving an electronic document request data object from the signor client device; and providing an electronic document data object associated with the electronic document request data object to the signor client device, wherein the electronic signature request data object is received in response to user engagement with the electronic document data object via the signor client device.

Alternatively or additionally, in some embodiments of the computer-implemented method, the electronic signature request data object further comprises device location data associated with the signor client device, and the method further comprises identifying proximity data associated with the signor client device; and comparing the device location data and the proximity data for determining the device location data is within a geographic region defined by the proximity data.

Alternatively or additionally, in some embodiments of the computer-implemented method, the electronic signature request data object further comprises device user biometric data, and the method further comprises identifying confirmed biometric data associated with the signor client device; and comparing the device user biometric data and the confirmed biometric data to determine the device user biometric data matches the confirmed biometric data.

Alternatively or additionally, in some embodiments of the computer-implemented method, the electronic signature request data object further comprises device location data associated with the signor client device, and the method further comprises identifying proximity data associated with the signor client device; comparing the device location data and the proximity data to determine the device location data is not within a geographic region defined by the proximity data; and transmitting a signature denial error to the signor client device in response to the determination.

Alternatively or additionally, in some embodiments of the computer-implemented method, the electronic signature request data object further comprises device user biometric data, and the method further comprises identifying confirmed biometric data associated with the signor client device; comparing the device user biometric data and the confirmed biometric data determine the device user biometric data does not match the confirmed biometric data; and transmitting a signature denial error to the signor client device in response to the determination.

Alternatively or additionally, in some embodiments of the computer-implemented method, the method further comprises receiving, from an authentication service, a signing continuation signal in response to authentication, by the authentications service, of the device user identity associated with the signor client device.

In some other example embodiments, a computer program product for frictionless electronic signature management is provided. The computer program product comprises a non-transitory computer readable storage medium having computer program instructions stored thereon. The computer program instructions, when executed by a processor, are configured for receiving, from a signor client device, an electronic signature request data object comprising electronic signature request information; identifying device identification information associated with the signor client device; associating at least a portion of the device identification information with at least an electronic document data object to identify an associated signing information set; and storing, to an electronic signature storage, an electronic signature data object based on the associated signing information set. In some such embodiments of the computer program product, the electronic signature storage comprises an electronic signature blockchain.

Alternatively or additionally, in some embodiments of the computer program product, the device identification information associated with the signor client device is identified, using a header enrichment process, from a network device associated with a trusted network provider.

Alternatively or additionally, in some embodiments of the computer program product, the computer program instructions are further configured for receiving an electronic document request data object from the signor client device; and providing an electronic document data object associated with the electronic document request data object to the signor client device, wherein the electronic signature request data object is received in response to user engagement with the electronic document data object via the signor client device.

Alternatively or additionally, in some embodiments of the computer program product, the electronic signature request data object further comprises device location data associated with the signor client device, and the computer program instructions are further configured for identifying proximity data associated with the signor client device; and comparing the device location data and the proximity data for determining the device location data is within a geographic region defined by the proximity data.

Alternatively or additionally, in some embodiments of the computer program product, the electronic signature request data object further comprises device user biometric data, and the computer program instructions are further configured for identifying confirmed biometric data associated with the signor client device; and comparing the device user biometric data and the confirmed biometric data to determine the device user biometric data matches the confirmed biometric data.

Alternatively or additionally, in some embodiments of the computer program product, the electronic signature request data object further comprises device location data associated with the signor client device, and the computer program instructions are further configured for identifying proximity data associated with the signor client device; comparing the device location data and the proximity data to determine the device location data is not within a geographic region defined by the proximity data; and transmitting a signature denial error to the signor client device in response to the determination.

Alternatively or additionally, in some embodiments of the computer program product, the electronic signature request data object further comprises device user biometric data, and the computer program instructions are further configured for identifying confirmed biometric data associated with the signor client device; comparing the device user biometric data and the confirmed biometric data determine the device user biometric data does not match the confirmed biometric data; and transmitting a signature denial error to the signor client device in response to the determination.

Alternatively or additionally, in some embodiments of the computer program product, the computer program instructions are further configured for receiving, from an authentication service, a signing continuation signal in response to authentication, by the authentications service, of the device user identity associated with the signor client device.

In yet some other example embodiments, another apparatus for frictionless electronic signature management is provided. The apparatus comprises at least one processor and at least one memory, the at least one memory having computer-coded instructions thereof. The computer-coded instructions are configured to, in execution with the at least one processor, configure the apparatus to receive user signing request information in response to user engagement; identify a signing request destination URL associated with the user signing request information; access the signing request destination URL to cause transmission of device identification information to an authentication system via a header enrichment process, and provide, to a signature management system, an electronic signature request data object associated with the user signing request information, the electronic signature request data object comprising at least electronic document data object identification information; and receive an electronic signature response data object from the signature management system.

Additionally or alternatively, in some embodiments of the apparatus, to receive the user signing request information, the apparatus is configured to capture a parseable image using at least one image capture device; parse the parseable image to identify encoded visual indicia; and decode the encoded visual indicia to receive the user signing request information. In some such embodiments of the apparatus, the parseable image comprises a QR code.

Additionally or alternatively, in some embodiments of the apparatus, the apparatus is further configured to transmit an electronic document request data object associated with a selected electronic document data object; receive the selected electronic document data object; and render an electronic document signing interface associated with the selected electronic document data object, wherein the user signing request information is received in response to the user engagement with the electronic document signing interface.

Additionally or alternatively, in some embodiments of the apparatus, to identify the signing request destination URL, the apparatus is configured to parse the user signing request information. Additionally or alternatively, in some embodiments of the apparatus, to identify the signing request destination URL, the apparatus is configured to identify a pre-determined signing request destination URL.

Additionally or alternatively, in some embodiments of the apparatus, the apparatus is further configured to receive device location data, wherein the electronic signature request data object further comprises the device location data for use in a device user authentication process.

Additionally or alternatively, in some embodiments of the apparatus, the apparatus is further configured to receive user biometric data, wherein the electronic signature request data object further comprises the user biometric data for use in a device user authentication process.

In yet other example embodiments, another computer-implemented method for frictionless electronic signature management is provided. The computer-implemented method comprises receiving user signing request information in response to user engagement; identifying a signing request destination URL associated with the user signing request information; accessing the signing request destination URL for causing transmission of device identification information to an authentication system via a header enrichment process, and providing, to a signature management system, an electronic signature request data object associated with the user signing request information, the electronic signature request data object comprising at least electronic document data object identification information; and receiving an electronic signature response data object from the signature management system.

Additionally or alternatively, in some embodiments of the computer-implemented method, receiving the user signing request information comprises capturing a parseable image using at least one image capture device; parsing the parseable image to identify encoded visual indicia; and decoding the encoded visual indicia to receive the user signing request information. In some such embodiments of the computer-implemented method, the parseable image comprises a QR code.

Additionally or alternatively, in some embodiments of the computer-implemented method, the method further comprises transmitting an electronic document request data object associated with a selected electronic document data object; receiving the selected electronic document data object; and rendering an electronic document signing interface associated with the selected electronic document data object, wherein the user signing request information is received in response to the user engagement with the electronic document signing interface.

Additionally or alternatively, in some embodiments of the computer-implemented method, identifying the signing request destination URL comprises parsing the user signing request information. Additionally or alternatively, in some embodiments of the computer-implemented method, identifying the signing request destination URL comprises identifying a pre-determined signing request destination URL.

Additionally or alternatively, in some embodiments of the computer-implemented method, the method further comprises receiving device location data, wherein the electronic signature request data object further comprises the device location data for use in a device user authentication process.

Additionally or alternatively, in some embodiments of the computer-implemented method, the method further comprises receiving user biometric data, wherein the electronic signature request data object further comprises the user biometric data for use in a device user authentication process.

In yet other example embodiments, another computer program product for frictionless electronic signature management is provided. The computer program product comprises a non-transitory computer-readable storage medium having computer program instructions stored thereon. The computer program instructions, when executed by a processor, are configured for receiving user signing request information in response to user engagement; identifying a signing request destination URL associated with the user signing request information; accessing the signing request destination URL for causing transmission of device identification information to an authentication system via a header enrichment process, and providing, to a signature management system, an electronic signature request data object associated with the user signing request information, the electronic signature request data object comprising at least electronic document data object identification information; and receiving an electronic signature response data object from the signature management system.

Additionally or alternatively, in some embodiments of the computer program product, receiving the user signing request information comprises capturing a parseable image using at least one image capture device; parsing the parseable image to identify encoded visual indicia; and decoding the encoded visual indicia to receive the user signing request information. In some such embodiments of the computer program product, the encoded visual indicia comprises a QR code.

Additionally or alternatively, in some embodiments of the computer program product, the computer program instructions are further configured for transmitting an electronic document request data object associated with a selected electronic document data object; receiving the selected electronic document data object; and rendering an electronic document signing interface associated with the selected electronic document data object, wherein the user signing request information is received in response to the user engagement with the electronic document signing interface.

Additionally or alternatively, in some embodiments of the computer program product, identifying the signing request destination URL comprises parsing the user signing request information. Additionally or alternatively, in some embodiments of the computer program product, identifying the signing request destination URL comprises identifying a pre-determined signing request destination URL.

Additionally or alternatively, in some embodiments of the computer program product, the computer program instructions are further configured for receiving device location data, wherein the electronic signature request data object further comprises the device location data for use in a device user authentication process.

Additionally or alternatively, in some embodiments of the computer program product, the computer program instructions further configured for receiving user biometric data, wherein the electronic signature request data object further comprises the user biometric data for use in a device user authentication process.

In yet another example embodiment, another apparatus for frictionless electronic signature management is provided. The apparatus comprises means for receiving, from a signor client device, an electronic signature request data object comprising electronic signature request information. The apparatus further comprises means for identifying device identification information associated with the signor client device. The apparatus further comprises means for associating at least a portion of the device identification information with at least an electronic document data object to identify an associated signing information set. The apparatus further comprises means for storing, to an electronic signature storage, an electronic signature data object based on the associated signing information set.

In yet another example embodiment, another apparatus for frictionless electronic signature management is provided. The apparatus comprises means for receiving user signing request information in response to user engagement. The apparatus further comprises means for identifying a signing request destination URL associated with the user signing request information. The apparatus further comprises means for accessing the signing request destination URL, including means for causing transmission of device identification information to an authentication system via a header enrichment process, and means for providing, to a signature management system, an electronic signature request data object associated with the user signing request information, the electronic signature request data object comprising at least electronic document data object identification information. The apparatus further comprises receiving an electronic signature response data object from the signature management system.

It should be appreciated that, in some embodiments, an example apparatus may be provided for any of the above-described methods and/or methods described herein. For example, example apparatuses may include at least one processor and at least one memory, the memory including computer-coded instructions for performing any of the methods described herein. Similarly, an example computer program product may be provided for any of the above-described methods and/or methods described herein. For example, example computer program products may include at least one non-transitory computer-readable storage medium having computer program instructions thereon, the computer program instructions, in execution with a processor, configured for performing any of the methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2A illustrates a block diagram of an example apparatus that may be specially configured in accordance with an example embodiment of the present disclosure;

FIG. 2B illustrates another block diagram of another example apparatus that may be specially configured in accordance with an example embodiment of the present disclosure;

FIG. 3 illustrates a data flow diagram depicting operational data flow of an example system in accordance with an example embodiment of the present disclosure;

FIGS. 4-7 illustrate flowcharts depicting various operations performed in an example process for frictionless electronic signing in accordance with the perspective of a first example embodiment of the present disclosure; and

FIGS. 8-9 illustrate flowcharts depicting various operations performed in an example process for frictionless electronic signing in accordance with the perspective of a second example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Documents requiring signing have been utilized in various contexts throughout history. Documents may be physically exchanged and signed by one or more parties to show that the signing parties certify, authorize, authenticate, or otherwise agree to the document. For example, non-limiting examples of such document signing include contract signing, letter signing, certified notification signing, and the like.

Electronic online systems enable users to utilize various devices to connect to the system and provide electronic signatures for documents. Such systems may be configured to enable a user to provide an electronic signature over a network, such as the Internet, such that multiple users may each provide a signature for one or more documents without the users being proximate to one another. Document signing, whether performed electronically or on paper, relies on the identity of each signor being authentic. To preserve system integrity, in a circumstance where Jane Doe is to provide a signature, no other unauthorized user should be able to provide that signature.

Particular problems for user identity authentication are posed in electronic systems for document signing due to the distributed nature of signors and/or requestors (e.g., a user providing a document for signing). A user identity could be authenticated via user registration and confirmation. For example, a system may utilize a conventional methodology that requires a user to register login credentials (e.g., a username and password) with the system, and provide the login credentials prior to use of the system to confirm the user is who they claim to be. Additionally or alternatively, a system may use a conventional methodology that uses a public key infrastructure (PKI), or other key management infrastructure, where a user registers with one or more parties to receive one or more key(s), and utilizes the key(s) to authenticate their identity using cryptographic signatures.

Such conventional systems, and indeed all conventional systems, suffer from a myriad of technical and user experience problems. For example, conventional systems require that a user undergo a registration, provisioning, and/or other registration process, to create and/or receive data to be used for authentication. In the above-described login context, a user must first register such login credentials before the user can utilize the system. Similarly, in the above-described PKI or key management contexts, a user must register with an authority to generate and/or receive key(s) for use in user identity authentication.

By requiring each user register with the system, such conventional systems must dedicate computing resources (including, but not limited to, networking resources, processing resources, memory resources, and/or the like) to the user registration and provisioning process. Overall system performance is thus affected, and n circumstances where computing resources are limited may be affected significantly. Further, requiring that each user register with the conventional system diminishes the overall user experience. The registration process wastes a user's time, and often can involve several steps and/or platforms that may cause difficulties in completing registration successfully. Additionally or alternatively, after registration is complete, such registration processes rely on the user to remember, or otherwise maintain, their registered login credentials. Additional problems may result if a user forgets or loses their login credentials.

Conventional systems further are problematic in requiring that a user maintain the secrecy of some or all of their registered and/or provisioned information. For example, in the login context, the system relies on the user to keep their login credentials (or at least a password portion, for example) as a secret from others. In the above-described PKI context, a private key must be kept secret from other users. Such systems are vulnerable to a myriad of cyber-security threats. For example, a user may accidentally discloses their secret information to an untrusted user or to the public. Alternatively, a malicious user may attempt to receive or identify such secret information from another user, for example through phishing, hacking, or other means. Further, even if a user does maintain the secrecy of their secret information, the user's secret information may nevertheless be exposed through a security breach or other vulnerability. Once exposed and/or received, a malicious user may utilize the secret information to impersonate the user in communications with the system. In the specific context of electronic signing, a malicious user could use the secret key of another user to perform any number of actions while masquerading as the other user, linking the other user to various actions that may have temporary and/or permanent effects of various severity to the user or third-party entities.

In this regard, various embodiments of the present disclosure provide frictionless electronic signature management, for example by verifying a user identity using device identification information that may be authenticated using by a third-party verification process. As a user utilizes a particular client device to communicate with one or more systems, the device identification information may be identified automatically as associated with the client device, such that the user need not provide the device identification information. The device identification information may be uniquely associated with a particular client device that is generally under exclusive control or authority of a particular user, such that authentication of the device identification information serves as a proxy for authenticating the identity of the user. In a particular context, for example, a user may utilize a mobile phone to perform various actions. Mobile phones have become as ubiquitous in society as a wallet or purse, are often kept in close proximity to their owner or authenticated user, and are often in the exclusive control of the associated owner or authenticated user. Further, in circumstances where a mobile device is lost, stolen, or otherwise no longer under the control of an intended user, the mobile device is often passcode, pass pattern, or passphrase protected, and further may be protected using one or more biometrics, to ensure that only an authenticated user gains access to the device. Other client devices may be associated with a particular user by nature of the environment in which the device is used. For example, additionally or alternatively to the above-described protections, an Internet of Things (IoT) enabled device or personal home device may be physically located in a user's home or other environment under exclusive control of the user.

Various embodiments, for example, are directed to a signature management system embodied by a signature management apparatus that is configured to provide frictionless electronic signature management of electronic document data objects using such device identification information. For example, the signature management apparatus may utilize device identification information to authenticate a particular user identity associated with a particular client device before enabling the user to provide an electronic signature associated with an electronic document data object. Upon authentication of the user identity, the apparatus may generate an electronic signature data object associated with, and in some embodiments based on, the device identification information, and store the electronic signature data object associated with a corresponding electronic document data object. In some embodiments, the signature management apparatus may store the electronic signature data object(s) in an electronic signature blockchain, for example to ensure that electronic signatures are stored as immutable, and/or to enable a distributed user set to easily query for stored electronic signature data objects. A user may query for electronic signature data objects associated with an electronic document data object to determine if a particular user has provided one or more verifiable electronically signature(s) for the electronic document data object. The signature management apparatus may further store a variety of information received associated with an electronic signature request data object, for example captured image data, information manually provided and/or input by a user via a client device, metadata, and/or the like.

Additionally, various embodiments are directed to a client device embodied by a client apparatus that is configured to provide frictionless electronic signature management. For example, the client apparatus may be configured to enable a user to generate and/or otherwise transmit an electronic signature request data object to a signature management system. In some embodiments, the client apparatus may be configured to enable manual user input of user signing request information to be used in generating and/or transmitting the corresponding electronic signature request data object. Additionally or alternatively, the client apparatus may be configured to enable capture, and/or analysis, of a parseable image to receive at least a portion of user signing request information to be used in generating and/or transmitting the corresponding electronic signature request data object. Using captured image data, the client apparatus may enable a user to provide an electronic signature to a physical document, and may enable signing in a frictionless manner to be performed in real-time without requiring user registration. The client apparatus may, for example, execute a specially configured service application (for example, a web application accessed via a browser application, or a native application) that causes rendering of various interfaces to access such functionality.

Embodiments of the present disclosure improve overall system efficiency and system security, as well as improve the user experience associated with providing one or more electronic signature(s). In some embodiments that leverage user device information for user identity authentication, computing resources may be saved or re-allocated to other processes rather than being allocated towards user registration processes. Additionally, in this regard, a user may begin use of the system immediately without undergoing a registration and provisioning process, improving the user experience while nonetheless maintaining user attribution and customizability. Further, embodiment systems leverage the security of device identification information to improve system security by maintaining secure authentication processes that do not require action by users, who may be tricked, unsophisticated, or otherwise vulnerable to a myriad of cybersecurity threats.

### Definitions

As used herein, the terms “data,” “content,” “information,” and similar terms may be used interchangeably to refer to data capable of being transmitted, received, and/or stored, for example in one or more “data object(s),” in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network” or “communications network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like. The client devices described herein communicate with one or more systems or servers, for example an authentication system and/or a signature management system, via one or more communication network(s). The term “signor client device” refers to a particular client device transmitting an electronic signature request data object to a signature management system.

The term “electronic signature request data object” refers to electronically transmitted data, transmitted from a client device to a signature management system, that indicates a user associated with the client device desires to provide an electronic signature associated with a particular electronic document data object. In some embodiments, an electronic signature request data object is transmitted to sign an electronic document data object in a frictionless manner (e.g., without requiring subsequent affirmative user action for the user to authenticate their identity). In this regard, in some such embodiments, information within the electronic signature request data object may be used to authenticate a user identity associated with the sender of the electronic signature request data object, such that the user submitting the electronic signature request data object may not be required to further provide authentication credentials and/or identifying information.

The term “electronic signature request information” refers to data or information included in an electronic signature request data object and utilized by an signature management system to facilitate processing of an electronic signature request data object. In some embodiments, electronic signature request information includes metadata associated with, or otherwise included in, an electronic signature request data object. In some embodiments, electronic signature request information includes one or more of (1) device identification information associated with a client device transmitting the request, (2) electronic document data object identification information (or an electronic document data object), (3) a request timestamp, (4) image data, or (5) any combination thereof.

The term “device identification information” refers to electronically managed data or information that uniquely identifies a particular client device, or confirms authentication of the identity of a client device. In some embodiments, device identification information is verifiable by, or is indicated as verifiable by, one or more third-party systems using secure information authentication processes. In some such embodiments, due to the nature of the client device being kept in close proximity to and/or control by an associated user, authentication of device identification information confirms identity of a user associated with the device identification information. Non-limiting examples of device identification information include an international mobile subscriber identity (IMSI) or telephone number, international mobile equipment identifier, integrated circuit card identifier (ICCID), media access control (MAC) address, and internet protocol (IP) address. In some embodiments, a trusted third-party device and/or system is configured to identify device identification information associated with a client device using a highly-secure process.

The term “associated signing information set” refers to a portion, or all, of electronic signature request information of an electronic signature request data object received by a signature management system and that is linked, or otherwise corresponds to, particular device identification information. For example, in some embodiments, a signature management system may associate at least a portion of electronic signature request information with device identification information injected into an electronic signature request data object using a header enrichment process. Alternatively, in some embodiments, a third-party system (such as a network device) may transmit device identification information associated with a session or other identifier, and the electronic signature request data object may be associated with the session or other identifier, such that the signature management system can create the associated signing information set by pairing the session or other identifier.

The term “electronic signature data object” refers to electronically managed data that represents electronic signing, by a user that had their identity authenticated, of an electronic document data object or a portion thereof. Each electronic signature data object is linked to at least a portion of an electronic document data object, and can be verifiably attributed to a particular user and/or client device associated with a particular user. In some embodiments, an electronic signature data object includes at least an associated signing information set. In some embodiments, the electronic signature data object comprises a cryptographic signature generated using data associated with the user and/or client device, for example generated using device identification information and/or an associated signing information set.

The term “electronic signature blockchain” refers to a fully-distributed or semi-distributed data storage configured to store one or more electronic signature data object(s) in a secure manner. In some embodiments, an electronic signature blockchain is immutable, such that under designed circumstances, electronic signature data objects stored to the electronic signature blockchain cannot be arbitrarily altered, re-ordered, or otherwise reorganized within the data storage.

The term “electronic document data object” refers to electronically managed data or information that represents an electronically generated document, or represents an electronically managed version of a physical document. In some embodiments, an electronic document data object set comprising zero or more electronic document data objects is stored by a signature management system, or by a third-party system communicable with a signature management system. An electronic document data object is configured to be electronically signed at least once by one or more users via corresponding client devices, for example by associating one or more electronic signature data objects with the electronic document data object. Non-limiting examples of an electronic document data object comprises electronically managed data embodying or representing a document, contract, letter, or other verifiable document. The terms “electronic document data object identification information,” and “electronic document data object identifier” refer to an electronically managed string, number, alphanumeric code, or other identifier that uniquely identifies an electronic document data object maintained by a signature management system or an associated third-party system. It should be appreciated that, in some embodiments, an electronic document data object may be embodied in any of a number of known or custom file formats.

The term “signature denial error” refers to electronic data signals generated by a signature management system and transmitted to a signor client device that indicates an electronic signature request data object was not successfully processed due to one or more identity authentication failures, and/or data processing failures. In some embodiments, a signature denial error includes an error message and/or error code that indicates a reason the electronic signature request data object was not successfully processed. In some embodiments, a signature management system includes a signature denial error in an electronic signature response data object transmitted from the signature management system to a signor client device.

The term “trusted network provider” refers to an entity, such as a corporation, individual, group, brand operator, or the like, in control of a communications network over which a client device communicates with one or more devices, systems, or other computing hardware. In some embodiments, a trusted network provider controls a communications network enabling communications between a client device and a signature management system. Non-limiting examples of a trusted network provide include a carrier associated with providing mobile services to a client device embodied by a mobile device.

The term “network device” refers to computing hardware, circuitry, component(s), system(s), or sub-system(s) of a communications network configured for receiving and/or relaying information and/or data objects, for example request data objects and response data objects, between various systems, devices, or the like. In some embodiments, a communications network includes a plurality of network devices, each network device configured to communicate with one or more other network devices and/or one or more client devices, systems, and/or the like. In some embodiments a network device is configured to perform one or more operations and/or processes for identifying device identification information associated with an entity and/or device linked to the information or data object being transmitted. In some embodiments, as a non-limiting example, a network device is configured to perform a header enrichment process, another DAA authentication process, or any other network-based authentication process.

The term “header enrichment process” refers to a process for authenticating a client device or a user of the client device (for example, a mobile device) via a Direct Autonomous Authentication process, involving a packet header enrichment in which packet headers comprise device identification information, for example, injected therein by a trusted party such as a carrier, network provider or through a login process. For example, in some embodiments, a network injects a phone number associated with a mobile device within packet headers. In this manner, the authentication system may obtain device identification information without user input. Application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

The term “device location data” refers to electronically managed information or data identifying a particular geographic location at which the client device is located or otherwise associated with a client device. In some embodiments, device location data is collected, captured, or otherwise identified by one or more associated devices, components, hardware configurations, or sub-systems of a client device. In some embodiments, device location data is collected and/or determined by one or more systems, components, or specialized hardware and/or software associated with the client device. Non-limiting examples of device location data include GPS information, longitude and latitude coordinates, address information, triangulation information or results, an IP address, or the like.

The term “stored proximity data” refers to electronically managed information or data that represents a geographic area associated with a particular client device, where the client device is authorized to act within the geographic zone. In some embodiments, stored proximity data is stored by a signature management system associated with device identification information for each corresponding client device,

The term “device user biometric data” refers to data or information embodying a biometric characteristic of a user received via interaction and/or engagement with a client device. Non-limiting examples of device user biometric data include fingerprint scan data, iris scan data, face scan data, walking gait scan data, handprint scan data, passcode data, pass pattern data, or other data associated with a physical or mental property of a user.

The term “confirmed biometric data” refers to data or information stored by an authentication system or signature management system associated with a particular client device or device identification information for use in comparing to received device user biometric data. For example, in some embodiments, an authentication system receives device user biometric data from a client device associated with received device identification information, and retrieves stored confirmed biometric data for comparison to identify the identity of the user associated with the client device.

The term “user signing request information” refers to electronically managed data or information captured, collected, or otherwise received by a client device for use in generating and/or transmitting an electronic signature request data object to a signature management system, and/or for use by the signature management system to process the electronic signature request data object. In some embodiments, user signing request information includes (1) electronic document data object identification information, (2) device identification information, (3) user authentication credentials, (4) image data, (5) URL data, (6) data processing instructions, or (7) any combination thereof. In some embodiments, a client device captures and/or identifies user signing request information, uses a first portion of user signing request information (e.g., a signing request destination URL) to transmit an electronic signature request data object including a second portion of user signing request information. In some embodiments, a client device is configured to capture, collect, or otherwise receive a parseable image including user signing request information.

The term “signing request destination URL” refers to a specially configured uniform resource locator identifying a target device, component, and/or system to which the client device should transmit an electronic signature request data object for processing by a signature management system. In some embodiments, the signing request destination URL is associated with a network device configured to receive an electronic signature request data object, perform a header enrichment process, and forward the electronic signature request data object and/or corresponding device identification information to one or more of an authentication system and a signature management system. In some embodiments, the signing request destination URL terminates at a network device included in a trusted provider network. In other embodiments, the signing request destination URL terminates at an authentication system or a signature management system.

The term “user engagement” refers to any interaction received and/or detected by a client device, and interpretable by the client device for performing one or more associated processes. In some embodiments, a client device is configured using a combination of hardware and specially configured software (e.g., a specially configured service application). Non-limiting examples of user engagement include button presses, taps, eye movements, voice commands, gestures, keystrokes, mouse clicks, peripheral interactions, and/or the like. In some embodiments, in an example context, a client device is configured to activate one or more hardware components in response to user engagement. In an example context, a client device is configured to receive user signing request information input by a user of the client device in response to user engagement, for example by capturing a parseable image using one or more image capture device(s) in response to user engagement.

The term “authentication system” refers to computing hardware, circuitry, server, device, system, or sub-system configured to verify the identity of a user and/or of a client device associated with a received request data object. In some embodiments, the authentication system is configured to identify and/or authenticate device identification information. Additionally or alternatively, in some embodiments, an authentication system is configured to communicate the results of an authentication process to a signature management system. In some embodiments, the authentication system is a sub-system of a signature management system. In other embodiments, the authentication system is another systems separate from but communicable with the signature management system, and controlled by the same entity. In yet other embodiments, the authentication system is a third-party system separate from but communicable with the signature management system, and controlled by a third-party entity. In some embodiments, the authentication system is configured to receive and/or identify device identification information indirectly from a client device using a packet header enrichment process, DAA process, or other network-based authentication process. In some embodiments, the authentication system automatically verifies received device identification information, for example when device identification information is received via a header enrichment process, such that the process used to identify the device identification information is secure enough to be immediately trusted. In some embodiments, received device identification information is compared to stored information and/or received information to determine whether the information matches.

In some embodiments, the authentication system controls process flow of a signature management system. For example, in some embodiments, the authentication system is configured to transmit a continuation signal to cause the signature management system to continue processing a request upon successfully verifying the identity of a user or client device. Similarly, in some embodiments, the authentication system is configured to transmit a termination signal, for example a signature denial error, to cause the signature management system to terminate processing of a request upon failing to verify the identity of a user or client device.

The term “signature management system” refers to computing hardware, circuitry, one or more devices, servers, systems, and/or sub-systems, configured for receiving an electronic signature request data object and processing the electronic signature request data object. In some embodiments, a signature management system maintains an electronic signature blockchain for enabling analysis of electronic signatures with respect to one or more corresponding electronic document data object(s). In some embodiments, the signature management system, alone or in conjunction with an authentication system, is configured to, upon request, automatically verify a user and/or client device used to create an electronic signature associated with a particular electronic document data object based on device identification information automatically received from the client device, for example using a packet header enrichment process, to facilitate frictionless electronic signature management.

The term “electronic signature response data object” refers to electronically generated data, information, and/or signals transmitted from a signature management system to a client device in response to a received electronic signature request data object. In some embodiments, in an example context, an electronic signature response data object includes a signature denial error that indicates the electronic signature request data object could not be completely processed. In another example context, an electronic signature response data object includes information indicating that an electronic signature data object associated with a received electronic signature request data object was successfully created and stored. In some such embodiments, the electronic signature response data object may include information associated with or identifying the generated electronic signature data object.

The term “image capture device” refers to one or more hardware components, devices, circuitry, and/or sub-systems, and/or associated software and/or firmware, of a client device for capturing image data. Non-limiting examples of an image capture device include a camera, imagery sensor(s), environment reconstruction system, and the like. In some embodiments, an image capture device is configured, through hardware and/or software, to capture a parseable image for processing by the client device.

The term “parseable image” refers to image data captured, collected, and/or otherwise received by a client device, where the image data is parseable to identify encoded visual indicia within the image data. In some embodiments, a client device is configured to parse the parseable image using one or more parsing methodologies to identify, or otherwise extract, the encoded visual indicia for analysis. In some embodiments, a parseable image is captured by an image capture device associated with a client device. For example, in some embodiments, a parseable image is a camera image, captured by a camera of a mobile device, for processing by the mobile device.

The term “encoded visual indicia” refers to data representing user signing request information in a visually detectable and/or decodable presentation. In some contexts, encoded visual indicia is printed, etched into, or otherwise provided associated with a physical document for capturing via a client device to facilitate electronic signing of the physical document. In some embodiments, encoded visual indicia is decodable, for example by a client device, using one or more decoding methodologies, to receive user signing request information. In some embodiments, encoded visual indicia is presented via an encoded pattern detectable and/or decodable by a specially configured client device. Non-limiting examples of encoded visual indicia include one or more QR code(s), barcode(s), character-encoded pattern(s) (for example, a binary encoded number, an encoded text string, or the like), encoded images, or encoded pattern(s) (for example, color-coded patterns), or a combination thereof.

### System Architecture and Example Apparatus

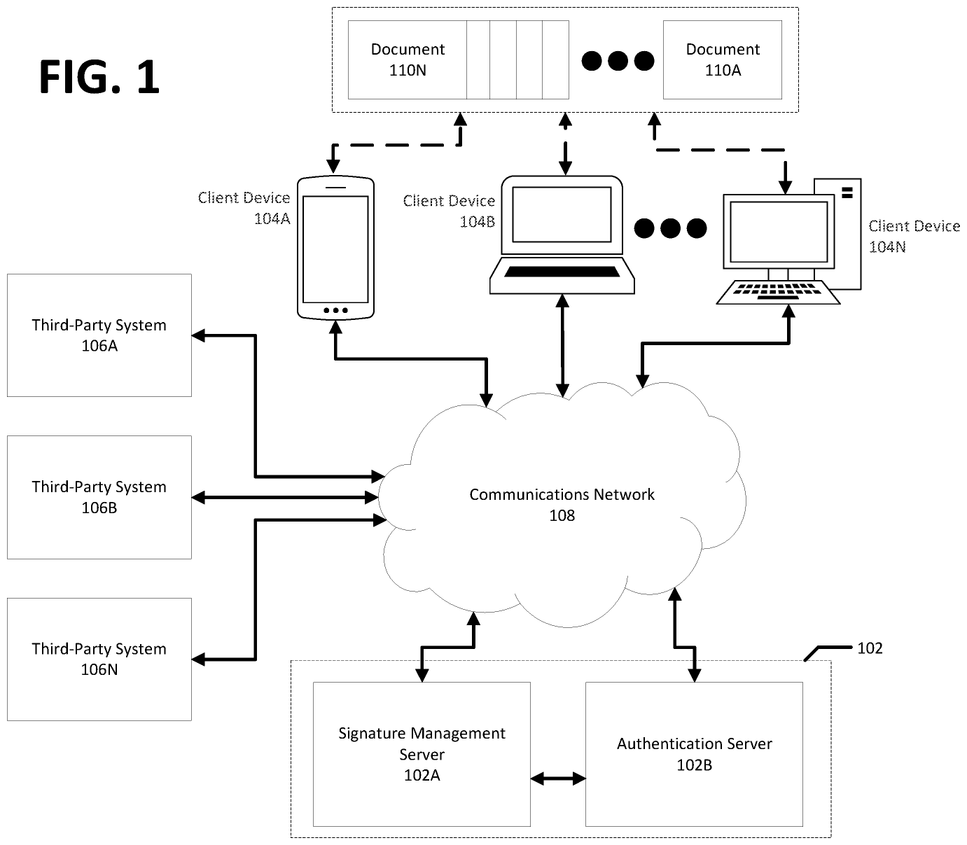

In this regard, FIG. 1 illustrates an example computing system in which embodiments of the present disclosure may operate. FIG. 1 illustrates an overview for a system configured for frictionless electronic signature management. Specifically, in such a system, one or more client devices may communicate with a signature management system, where the signature management system in communication with one or more third-party systems, for performing frictionless electronic signature management.

The system illustrated includes a signature management system 102 in communication with one or more client devices 104A-104N (collectively “client devices 104”). The signature management system 102, in some embodiments, is further in communication with one or more third-party systems 106A-106N (collectively “third-party systems 106”). The various systems may communicate over a communications network 108. In some embodiments, the various systems may communicate with the one or more client devices 104 and/or the one or more third-party systems 106 over a plurality of communications networks, including communications network 108, such as a carrier network and/or a Wi-Fi network.

Any number, or all, of the client devices 104 may be associated with or embodied by any number of known computing devices. For example, one or more of the client devices 104 may be embodied by a mobile phone, smart phone, tablet, laptop, personal computer, wearable device, set-top box, Internet-of-Things (IoT) device, or the like. Each of the client devices 104 may be associated with a user entity that rightfully owns, possesses, controls, or otherwise has permissible access to the corresponding client device. In some embodiments, each of the client devices 104 may be secured with one or more use security verification processes for gaining access to functionality provided by the client device (e.g., one or more passcode, fingerprint, face, or other biometric scan identity verification processes, or the like, or a combination thereof). In this regard, such devices may often be secured by a user (e.g., located in a home environment or other environment generally inaccessible to the public) or otherwise kept secure on the user (e.g., mobile devices kept in close proximity and control by the user, and reported if lost or stolen to have functionality terminated). Accordingly, receiving device identification information associated with one of the client devices 104 serves as a proxy for confirming the user's identity associated with the client device, as the user's identity has been successfully authenticated via the corresponding identity verification process(es).

Each of the client devices 104 may be configured to provide particular functionality associated with electronic signature management. In this regard, each client device may be configured via customized hardware, software, or a combination of hardware and software, to provide functionality for generating and/or transmitting one or more electronic signature request data object(s) associated with accessed documents. For example, the client devices 104 may be configured to interact with the documents 110A-110N (collectively “documents 110”). In some such embodiments, for example, each of the client devices 104 may be configured to receive user signing request information associated with providing an electronic signature associated with one or more of the documents 110 in response to user engagement via the client device. Each of the client devices 104 may use one or more components, such as sensors, cameras, peripherals, and/or the like, to receive the user signing request information. For example, in some embodiments, a user may utilize a camera or other image capture device associated with a client device to capture a parseable image for analysis by the corresponding client device to receive corresponding user signing request information. It should be appreciated that the documents 110 may embody any number of signable physical documents, or other materials, and/or digital documents and/or data.

The signature management system 102 may be embodied by one or more computing systems, apparatuses, devices, or the like, configured for frictionless electronic signature management. In this regard, the signature management system 102 includes one or more components, systems, apparatuses, devices, or the like, for receiving signals from and/or transmitting signals and/or corresponding data objects to various communicable devices, for example the client devices 104 and/or the third-party systems 106, and/or for performing one or more of the processes described herein. In some embodiments, the signature management system 102 includes a signature management server 102A. Additionally or alternatively, in some embodiments, the signature management system 102 includes an authentication server 102B. In other embodiments, the authentication server 102B may be external to the signature management system 102, for example where the authentication server 102B is a third-party controlled system communicable with the signature management system over a network, such as the network 108.

The signature management server 102A may be configured via hardware, software, or a combination of software and hardware to communicate with the one or more client devices 104 over a network, such as the network 108 or one or more sub-networks or associated networks therein. Additionally or alternatively, in some embodiments, the signature management server 102A may be configured for executing computer-coded instructions for one or more operations for receiving and/or processing request data objects received from various client devices, for example electronic signature request data objects. In this regard, the signature management server 102A may be configured for receiving an electronic signature request data object, identifying, parsing, and/or otherwise extracting information from the electronic signature request data object, performing one or more authentication processes based on the identified information, and storing a new electronic signature data object including at least a portion of the parsed and/or identified information. In performing one or more of the above actions, the signature management server may communicate with the client devices 104 and/or the third-party systems 106, for example using a network interface.

The signature management server 102A may include or be associated with one or more database(s) embodied in hardware, software, or a combination of software and hardware. In some embodiments, the database(s) may include at least one data storage device, such as one or more memory devices, hard disks, network attached storage (NAS) device(s), or a separate database server or servers. The database(s) may be configured for storing, retrieving, and/or otherwise maintaining data associated with electronic signature management. For example, in some embodiments, the database(s) may include device identification information and/or associated user data objects, electronic document data object(s), electronic signature data object(s), third-party system identification information and/or communication information, or the like. In some embodiments, for example, the database(s) may include an electronic signature blockchain managed by the signature management server 102A. In this regard, the signature management server 102A may be configured to store a new electronic signature data object to the electronic signature blockchain, and/or retrieve information from the electronic signature blockchain for various auditing, authentication, and/or other verification purposes.

The authentication server 102B may be configured for identifying, receiving, and/or retrieving information associated with a client device transmitting a request data object to the signature management system 102, including but not limited to device identification information, device location data, device user biometric data, authentication credentials, and/or the like. Additionally or alternatively, in some embodiments, the authentication server 102B is configured to perform one or more authentication and/or verification processes based on the identified, received, and/or retrieved information, to authenticate an identity of a user and/or client device. In some embodiments, the authentication server 102B is configured to identify and/or authenticate device identification information associated with a client device using a header enrichment process, DAA process, or other third-party verifiable information process. Additionally or alternatively, in some embodiments, the authentication server 102B may maintain one or more of its own databases and/or communicate with one or more database(s) maintained associated with another component, such as the signature management server 102A. The database(s) may be configured to store, maintain, and/or retrieve information related to the one or more authentication processes performed by the authentication server 102B. For example, the authentication server 102B may include or communicate with one or more database(s) that store device identification information, information embodying or associated with user biometrics, location data associated with client device(s), and/or the like. In some embodiments, the authentication server 102B communicates with or otherwise accesses database(s) similarly communicable and/or maintained by the signature management server 102A. Alternatively, in some embodiments, one or more of the database(s) operated by the authentication server 102B is shared between the signature management server 102A and the authentication server 102B. In yet other embodiments, the signature management server 102A and the authentication server 102B share access to all database(s).

Any number, or all, of the third-party systems 106 may be associated with or embodied by one or more server, device, or other computing hardware separate from the signature management system 102. In this regard, the third-party systems 106 may comprise hardware and/or software for retrieving, identifying, and/or authenticating device identification information associated with a particular client device. Each of the third-party systems 106 may be associated with a different third-party entity. For example, one or more of the third-party systems 106 may be associated with a hardware manufacturer, a device provider, a carrier, a software as a service provide associated with a particular service, or the like. For example, in some embodiments, a third-party system may be associated with a carrier entity for one or more of the client devices 104. For example, the third-party system 106A may be a carrier device associated with the carrier network, for example embodying the communications network 108, accessible to the client device 104A. The carrier device embodied by one of the third-party systems 106 may be configured to perform a header enrichment process to identify device identification information, such as a phone number, associated with a client device as the client device transmits requests to the signature management system 102. Other systems of the third-party systems 106 may utilize other identification and/or authentication processes to identify and/or authenticate device identification information verifiable by the third-party system. For example, in some embodiments, one or more of the third-party systems 106 is configured to authenticate credentials provided by or associated with the client device, location data, biometric data, and/or the like.

The authentication server 102B may communicate with one or more of the third-party systems 106 as part of one or more authentication processes. For example, the authentication server 102B may retrieve and/or otherwise receive device identification from one of the third-party systems 106. Additionally or alternatively, the authentication server 102B may communicate with one of the third-party systems 106 to authenticate information, for example device identification information, received by the authentication server 102B from one of the client devices 104. In some embodiments, any combination of a plurality of authentication processes may be performed (for example, a header enrichment process and at least one additional authentication process, or any third-party verifiable authentication process in lieu of a header enrichment process).

It should be appreciated that, in some embodiments, the signature management system 102 comprises only a single system that functions to perform the operations of both the signature management server 102A and authentication system 102B. Further, in some embodiments, the signature management system 102 may be configured to perform one or more additional, enhanced, and/or alternative operations as described herein. Such operations may be performed by the signature management server 102A, authentication server 102B, a combination thereof, a single server embodying a combination of the servers, and/or other servers or computing hardware not depicted. For example, in some embodiments, one or more databases may be embodied by one or more external server devices comprising and/or associated with memory storage devices.

The illustrated system includes network 108 for facilitating communications between the client devices 104 and signature management system 102, and for facilitating communications between signature management system 102 and the third-party systems 106. In some embodiments, the network 108 includes one or more sub-networks comprising a combination of shared and/or independent network devices. For example, network 108 may be embodied by, or include a sub-network embodied by, a carrier network comprising at least one carrier device controlled by a carrier entity, such as a mobile phone carrier entity associated with one or more of the client devices 104. One or more of the client devices 104 may communicate with the signature management system 102 via the carrier network, for example embodied by network 108 or a sub-network thereof, to enable one or more authentication processes, such as a DAA process, header enrichment process, and/or the like. In this regard, the carrier network may be an out-of-band network with respect to one or more other sub-networks, or other networks associated with the network 108 over which the client devices 104 can communicate, to prevent channel-based cyber-attacks and ensure verifiability of received information (such as device identification information). In some embodiments for example, the signature management system 102 may include a carrier device serving as an end-point for a header enrichment process via the carrier network, embodied by communications network 108. Additionally or alternatively in some embodiments, the network 108 may be embodied by any number of known network configurations, including, without limitation, one or more Wi-Fi networks, LAN networks, WLAN, networks, and the like, comprised of any number and/or combination of known network devices.

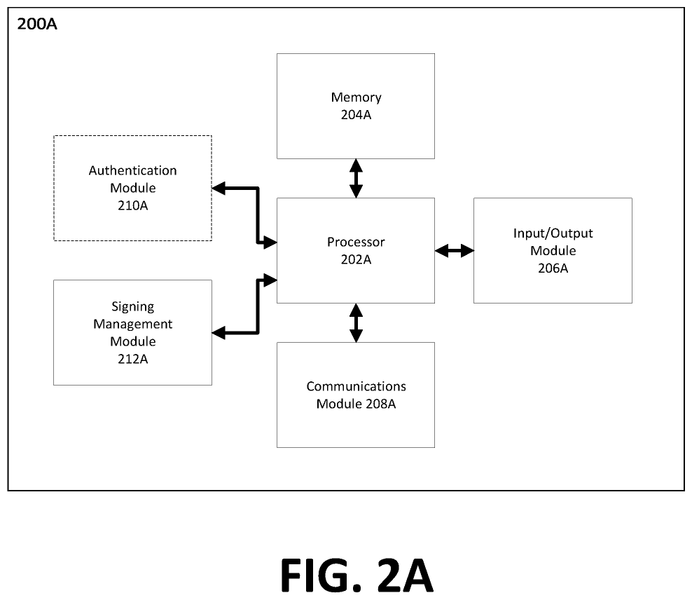

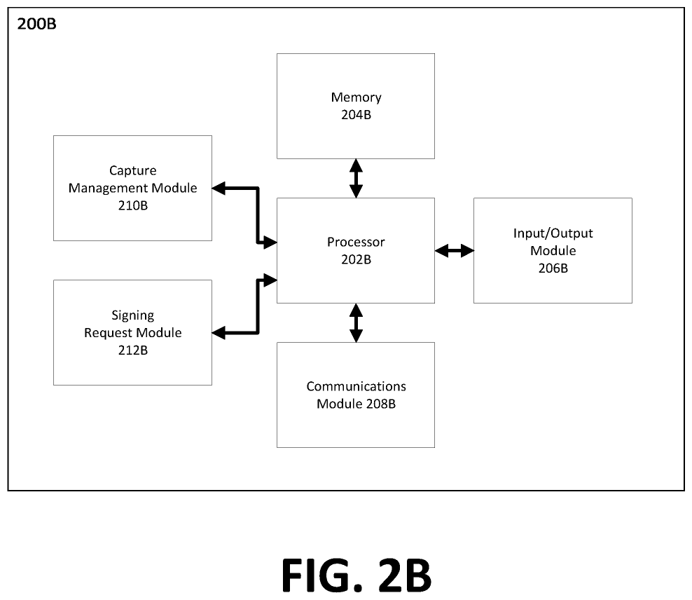

The signature management system 102, and/or one or more sub-devices thereof, may be embodied by one or more computing systems, devices, or apparatuses, for example the apparatus 200A depicted in FIG. 2A. As illustrated, the apparatus 200A may include several modules and/or components, such as processor 202A, memory 204A, input/output module 206A, communications module 208A, and signing management module 212A. In some embodiments, additionally or alternatively, the apparatus 200A includes authentication module 210A. The apparatus 200A may be configured, using such means as modules 202A-212A, to perform the operations described herein. Although these components 202A-212A are described with respect to functional limitations, it should be understood that a particular implementation necessarily includes the use of particular hardware. It should also be understood that certain of these components 202A-212A may include similar or common hardware. For example, two modules or sets of modules may both leverage the same processor, network, interface, storage medium, and/or the like, to perform their associated functions, such that duplicate hardware is not required for each module. The terms “module” and “circuitry” as used herein with respect to the components of the apparatus 200A should therefore be understood to include particular hardware configured to perform the functions associated with the particular component, as described herein.

Indeed, the terms “module” and “circuitry” should be understood broadly to include hardware and, in some cases, software and/or firmware for configuring the hardware. For example, in some embodiments, the term “module” may include processing circuitry, storage medium(s), network interface(s), input/output device(s), and the like. In some embodiments, the processor 202A (and/or co-processor and any other processing module assisting or otherwise associated with the processor) may be in communication with the memory 204A via a bus for passing information among components of the apparatus 200A. The memory 204A may be non-transitory and, for example, include one or more volatile and/or non-volatile memories. In other words, for example, the memory 204A may be an electronic storage device (e.g., a computer readable storage medium). The memory 204A may be configured to store information, content, applications, instructions, or the like, for enabling the apparatus to carry out various functions in accordance with example embodiments of the present disclosure.

The processor 202A may be enabled in a number of different ways and may, for example, include one or more processing devices configured to perform independently. Additionally or alternatively, the processor may include one or more processes configured in tandem with a bus to enable independent execution of instructions, pipelining, and/or multi-threading. The use of the terms “processor,” “processing module,” and “processing circuitry” may be understood to include a single core processor, a multi-core processor, multiple processors internal to the apparatus, and/or one or more remote or “cloud” processors.

The processor 202A may be configured to execute instructions stored in the memory 204A, or otherwise accessible to the processor. Additionally or alternatively, the processor may be configured to execute hard-coded functionality. As such, whether configured by hardware methods, software methods, or a combination thereof, the processor may represent an entity (e.g., physically embodied in the circuitry) capable of operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the apparatus 200A may include input/output module 206A that may, in turn, be in communication with processor 202A to provide output to the user and, in some embodiments, to receive an indication of user engagement. The input/output module 206A may comprise a user interface, which may include a display controlled by or associated with a web interface, a mobile application, and/or another user interface, or the like. In some embodiments, the input/output module 206A may include a keyboard, a mouse, a touch screen, touch areas, soft keys, a microphone, a speaker, and/or other input/output mechanisms. The processor and/or user interface module comprising the processor may be configured to control one or more elements of a user interface through computer program instructions (e.g., software and/or firmware) stored on a memory accessible to the processor such as memory 204A and/or the like.

The communications module 208A may be any means, such as a device, component, and/or circuitry, embodied in either hardware or a combination of hardware and software, that is configured to receive and/or transmit data from and/or to another system, device, module, circuitry, or the like, communicable with the apparatus 200A. The communications module 208A may include, for example, one or more network interfaces for enabling communications with one or more wired or wireless communication networks. For example, the communications module 208A may include, for example, one or more network interface cards, antennas, buses, switches, routers, modems, and/or supporting hardware and/or software, and/or any other device suitable for enabling communications via one or more network(s). Additionally or alternatively, the communications module 208A may include a communications interface including circuitry for interacting with the antenna(s) to cause transmission of signals via the antenna(s) or to handle receipt of signals via the antenna(s).

The authentication module 210A includes hardware, software, or a combination thereof, for receiving signals, data objects, or the like, for processing received signals to authenticate the identity of a client device and/or user associated with a client device. For example, the authentication module 210A may include hardware, software, or a combination thereof for receiving and/or identifying device identification information, device location data, device user biometric data, and/or the like from received signals and/or information received from a client device and/or third-party system, including but not limited to from received electronic signature request data object(s). Additionally or alternatively, the authentication module 210A may include hardware, software, or a combination thereof, for retrieving and/or identifying stored information utilized to authenticate the identity of a client device and/or user associated with a client device, for example stored proximity data, confirmed biometric data, authentication details (e.g., login credentials), and/or the like. Additionally or alternatively, the authentication module 210A may include hardware, software, or a combination thereof, for processing the received and/or identified information from the client device and/or external system with the retrieved and/or identified stored information. In this regard, the authentication module 210A may analyze the data to determine whether to authenticate a particular client device and/or user associated with a particular client device, and to generate and/or transmit a corresponding signal, error message, or combination thereof. In some embodiments, authentication module 210A may include software, hardware, or a combination thereof to make a determination as to whether the received and retrieved data matches, and generate one or more signals based on the determination.

It should be appreciated that, in some embodiments, the authentication module 210A performs one or more of the aforementioned operations alone, or in combination with one or more other modules of the apparatus 200A. For example, in some embodiments, the authentication module 210A may leverage the processor 202A for processing functionality and the communications module 208A for data reception functionality. In yet some embodiments, the authentication module 210A may include a separate processor, specially configured field programmable gate array (FPGA), or specially configured application specific integrated circuit (ASIC). The authentication module 210A is configured, in some embodiments, to perform one or more additional and/or alternative functions, and/or partial operations or whole operations described with respect to one or more other modules as illustrated.

The signing management module 212A includes hardware, software, or a combination thereof, for receiving signals, data objects, or the like, for processing electronic signature request data objects, and/or otherwise maintaining data associated with electronic signature management. For example, the signature management module 212A may include hardware, software, or a combination thereof, configured to identify device information associated with a signor client device. Additionally or alternatively, the signing management module 212A may include hardware, software, or a combination thereof, configured to identify and/or parse electronic signature request information from a received electronic signature request data object. Additionally or alternatively, the signing management module 212A may include hardware, software, or a combination thereof, to generate an electronic signature data object based on a received electronic signature request data object, or identified, parsed, and/or extracted electronic signature request information. Additionally or alternatively, the signing management module 212A may include hardware, software, or a combination thereof to generate and/or store an electronic signature data object to an electronic signature blockchain. Additionally or alternatively, the signing management module 212A may include hardware, software, or a combination thereof, configured to access and/or retrieve data, such as electronic signature data object(s) and/or associated metadata, from an electronic signature record blockchain and/or one or more other databases, repositories, or the like.

Additionally or alternatively, in some embodiments, the signing management module 212A may be configured to initiate one or more actions upon generating and/or storing an electronic signature data object. For example, in some embodiments, the signing management module 212A may include hardware, software, or a combination thereof, to initiate a digital transfer of electronically managed currency upon generation and/or storage of the new electronic signature data object. For example, the electronic signature data object may be associated with a first user and first user account and/or first device identification information, and the electronic document data object may have been generated by and/or submitted by a second user associated with a second user account and/or second device identification information. The signing management module 212A may be configured to initiate a transfer of electronically managed currency from the first user account to the second user account (or visa-versa), or initiate a transfer of electronically managed currency from the first device identification information to the second device identification information (or visa-versa).

In some embodiments, the signing management module 212A includes hardware, software, or a combination thereof, to maintain a database of electronic document data objects. In this regard, the signing management module 212A may receive information and/or a request to generate and/or store a new electronic document data object for electronic signing. The signing management module 212A may be configured to receive such information and/or request(s) from one or more client devices, and/or to process such information and/or request(s). In other embodiments, the electronic signature data object(s) managed by the signing management module 212A may be associated with electronic document data objects managed by another system, or may identify a corresponding document not associated with an electronic document data object.

It should be appreciated that, in some embodiments, the signing management module 212A performs one or more of the aforementioned operations alone, or in combination with one or more other modules of the apparatus 200A. For example in some embodiments, the signing management module 212A may leverage the processor 202A for processing functionality and/or the communications module 208A for data reception functionality. In yet some embodiments, the signing management module 212A may include a separate processor, specially configured FPGA, or specially configured ASIC. The signing management module 212A is configured in some embodiments, to perform one or more additional and/or alternative functions, and/or partial operations or whole operations described with respect to one or more other modules as illustrated.

It should be appreciated that all or some of the information and/or data managed or processed by the apparatus 200A is received, generated, and/or maintained by one or more of the components of the apparatus 200. In some embodiments, one or more external systems, including but not limited to third-party systems, client devices, remote cloud computing systems, remote data storage systems, and/or the like, may be leveraged to provide some or all of the functionality described herein.

One or more of the client devices 104 may be embodied by one or more computing systems, apparatuses, devices, or the like, for example apparatus 200B depicted in FIG. 2B. As illustrated in FIG. 2B, the apparatus 200B may include a processor 202B, memory 204B, input/output module 206B, communications module 208B, capture management module 210B, and signing request module 212B. In some embodiments, other elements of the apparatus 200B may provide or supplement the functionality of particular modules. For example, the processor 202B may provide processing functionality, the memory 204B may provide storage functionality, and the communications module 208B may provide network interface functionality, and the like. As it relates to the operations described in the present disclosure, the functioning of the processor 202B, the memory 204B, the input/output module 206B, and/or the communications module 208B may be similar to the similarly named components described above with respect to FIG. 2A. For the sake of brevity, additional description of the mechanics and functionality of these components is omitted. Nonetheless, these device components, whether operating alone or together, provide the apparatus 200B with the functionality necessary to facilitate the communication of data and information between the apparatus 200B and one or more devices and/or systems, such as a signature management system, over one or more network(s).

The capture management module 210B includes hardware, software, or a combination thereof for capturing user engagement and/or associated data, information, signals, and/or the like, for use in capturing user signature request information for initiating transmission of an associated electronic signature request data object. In some embodiments, the capture management module 210B comprises one or more image capture device(s), camera(s), sensor(s), and/or the like for capturing the environment of the apparatus 200B, for example in response to received user engagement. Additionally or alternatively, the capture management module 210B may include hardware, software, or a combination thereof, configured to process user engagement, activate one or more hardware components, and process data captured via the hardware components (or captured and pre-processed before further processing by the capture management module 210B).

For example, in some embodiments, the capture management module 210B includes hardware, software, or a combination thereof, configured to capture a parseable image using at least one image capture device. Additionally or alternatively, in some embodiments, the capture management module 210B includes hardware, software, or a combination thereof, configured to parse a captured parseable image to identify user signature request information. Additionally or alternatively, in some embodiments, the capture management module 210B includes hardware, software, or a combination thereof, to decrypt encrypted user signature request information. Additionally or alternatively, in some embodiments, the capture management module 210B includes hardware, software, or a combination thereof, to parse and/or identify information within identified and/or parsed user signature request information, for example one or more URLs, and/or the like.

It should be appreciated that, in some embodiments, the capture management module 210B performs one or more of the aforementioned operations alone, or in combination with one or more other modules of the apparatus 200B. For example, in some embodiments, the capture management module 210B leverages the processor 202B for processing functionality and/or the communications module 208B for data reception functionality. In yet some embodiments, the capture management module 210B may include a separate processor, specially configured FPGA, or specially configured ASIC. The capture management module 210B is configured, in some embodiments, to perform one or more additional and/or alternative functions, and/or partial operations or whole operations described with respect to one or more other modules as illustrated.

The signing request module 212B includes hardware, software, or a combination thereof, configured for processing information to generate and/or transmit an electronic signature request data object to a signature management system, and/or process response information associated with the request received from the signature management system. In some embodiments, the signing request module 212B includes, or is associated with, one or more hardware components having a specialized function to receive user and/or device data. Non-limiting examples include location services components, biometric scanning components, and/or the like, to provide some or all of the functionality described herein.

For example, in some embodiments, the signing request module 212B includes hardware, software, or a combination thereof, configured to identify user signing request information and/or parse or otherwise identify information therefrom, for example one or more signing request destination URLs. Additionally or alternatively, in some embodiments, the signing request module 212B includes hardware, software, or a combination thereof, configured to access a signing request destination URL. Additionally or alternatively, in some embodiments, the signing request module 212B includes hardware, software, or a combination thereof, configured to cause transmission of device identification information to an authentication system, which may be performed via one or more third-party verifiable processes, such as a header enrichment process. Additionally or alternatively, in some embodiments, the signing request module 212B includes hardware, software, or a combination thereof, configured to provide an electronic signature request data object associated with identified and/or received user signing request information, for example via transmission to a signature management system. Additionally or alternatively, in some embodiments, the signing request module 212B includes hardware, software, or a combination thereof, configured to receive response information, data objects, and/or the like, such as an electronic signature response data object, and to output such information and/or process the received response information, data objects, and/or the like for one or more subsequent actions. Additionally or alternatively, in some embodiments, the signing request module 212B includes hardware, software, or a combination thereof, configured to receive and/or identify device and/or user data, such as biometric data, location data, and/or the like.

In some embodiments, the signing request module 212B includes hardware, software, or a combination thereof for analyzing the electronic signature data objects associated with an electronic document data object. For example, the signing request module 212B may include hardware, software, or a combination thereof, for generating and/or transmitting a request to identify electronic signature data objects associated with an electronic document data object. For example, the signing request module 212B may generate a request to query an electronic signature blockchain based on an electronic document data object identifier, which may be entered by the user or extracted, parsed, or otherwise identified from a captured parseable image, for example. The signing request module 212B may, alone or in conjunction with one or more other modules, render an interface to enable a user to view and/or analyze the retrieved electronic signature data object(s), for example to determine who has provided an electronic signature associated with one or more portions of an electronic document data object.

Additionally or alternatively, in some embodiments, the signing request module 212B includes hardware, software, or a combination thereof, to transmit information to a signature management system to register and/or generate a new electronic document data object for electronic signing. The signing request module 212B may generate a request including such information for transmission to the signature management system, and/or one or more associated systems. In some embodiments, the signing request module 212B is configured to receive such information, for example in response to user engagement for inputting the information used to register a new electronic document data object. In this regard, for example, the signing request module 212B may be configured to generate and/or cause rendering of one or more interfaces configured for receiving such information, and processing user engagement received associated with the one or more interfaces.

It should be appreciated that, in some embodiments, the signing request module 212B performs one or more of the aforementioned operations alone, or in combination with one or more other modules of the apparatus 200B. For example, in some embodiments, the signing request module 212B leverages the processor 202B for processing functionality and/or the communications module 208B for data reception functionality. In yet some embodiments, the signing request module 212B may include a separate processor, specially configured FPGA, or specially configured ASIC. The signing request module 212B is configured, in some embodiments, to perform one or more additional and/or alternative functions, and/or partial operations or whole operations described with respect to one or more other modules as illustrated.

As described above and as will be appreciated based on this disclosure, embodiments of the present disclosure may be configured as methods, mobile devices, frontend graphical user interfaces, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

Particular embodiments of the subject matter have been described with respect to the embodiment descriptions provided above. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Example System Data Flow

Having thus described an example system and example apparatuses, an example data flow will now be described. It will be appreciated that the described data flows, operations and/or processes therein, and the like, are provided as non-limiting examples, and that embodiments may perform various data flows, processes, and/or operations in a myriad of ways using various system configurations.

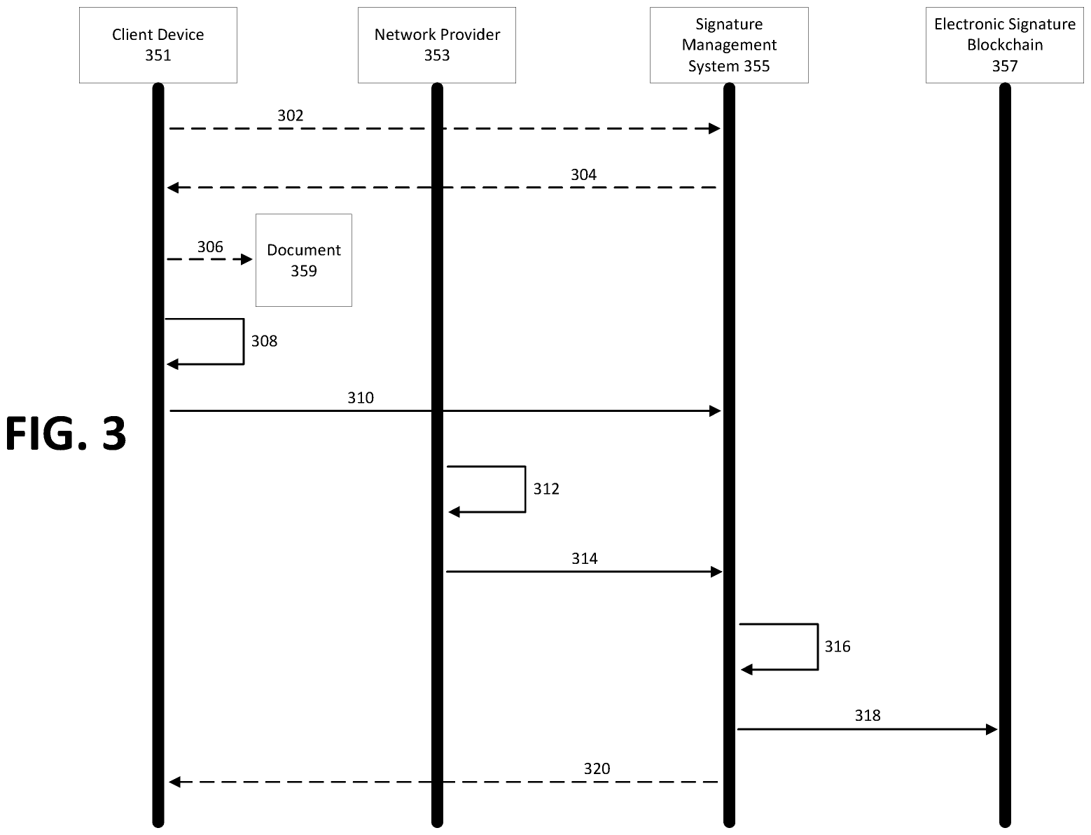

FIG. 3 illustrates a data flow diagram depicting example operations between devices, systems, and the like for frictionless electronic signature management. Specifically, FIG. 3 illustrates a data flow between client device 351, network provider 353, signature management system 355, and electronic signature blockchain 357, for frictionless electronic signature management associated with a document 359.

At optional step 302, the client device 351 may generate an electronic document data request and/or transmit an electronic document request data object to the signature management system 355. The electronic document request data object may indicate a user desire to retrieve a particular electronic document data object stored by the signature management system 355. The electronic document data object may, for example, represent a contract, document, or other item to receive an electronic signature. In some embodiments, the electronic document request data object may include electronic document data object identification information associated with the electronic document data object to be retrieved, such that the signature management system 355 may use the electronic document data object identification information, alone or in combination with other data within the electronic document request data object, to retrieve the requested electronic document data object.

In some embodiments, the client device may be configured to render an interface for selecting an electronic document data object to access. For example, the client device 351 may initially communicate with the signature management system 355, and/or one or more other systems, to display a document selection interface that includes all electronic document data objects associated with the client device 301, or in some embodiments stored associated with device identification information for the client device 301. Each electronic document data object may have an interface component rendered for selecting to access the electronic document data object corresponding to that interface component. In some embodiments, for example, each interface component may be configured to originate an electronic document request data object associated with the corresponding electronic document data object upon user engagement with the interface component.

At optional step 304, the signature management system 355 may transmit an electronic document data object response. The electronic document data object response may include the electronic document data object retrieved by the signature management system 355. By accessing the electronic document data object, the user may be able to view electronic document data object, for example via a display of the client device 301. In this regard, the client device 301 may be configured to render the electronic document data object in response to receiving the electronic document data object response.

Additionally or alternatively, in some embodiments, the client device 301 is configured to render an electronic document signing interface. The electronic document signing interface may be associated with the electronic document data object response. For example, the electronic document signing interface may provide at least one interface component configured to receive user engagement that indicates a user desire to electronically sign the electronic document data object. For example, in response to user engagement with the interface component, the client device 351 may receive user signing request information for use in generating and/or otherwise transmitting an electronic signature request data object. In some embodiments, the electronic document signing interface may be rendered to enable the user to electronically sign the electronic document data object multiple times and/or for different portions. For example, the electronic document data object may include multiple data portions, such that multiple portions are electronically signed individually by one or more users.

In some example contexts, at optional step 306, the signature client device 351, alone or via network provider 353, is configured to capture a parseable image from the document 359 for electronically signing. In this regard, the client device 351 may activate one or more components of the client device 351, such as one or more image capture devices, to capture a parseable image that includes encoded visual indicia on or associated with the document 359. In an example context, the document 359 may be embodied by a physical contract (e.g., a printed document) that includes encoded visual indicia that may be embodied by a QR code printed on a physical contact, or a particular portion of the physical contract. The parseable image, including the encoded visual indicia, may be captured and decoded for the client device 301 to receive user signing request information for processing. For example, the encoded visual indicia may be parsed from and decoded to receive user signing request information and generate and/or transmit a corresponding electronic signature request data object based on the user signing request information. Example user signing request information may include, without limitation, a signing request destination URL, electronic document data object identification information, device identification information, and/or the like.

It should be appreciated that, in some embodiments, the steps 302 and 304 may be performed, and step 306 not performed. For example, in this regard, a user may retrieve and analyze the electronic document data object via the client device 351, and provide user input associated with receiving user signing request information for generating and/or transmitting an electronic signature request data object. Alternatively, in other embodiments, step 306 may be performed, and steps 302 and 304 not performed. For example, in this regard, a user may analyze a physical document associated with an electronic document data object (or external rendering of an electronic document data object), and provide user engagement for capturing a parseable image to be analyzed by the client device 351 to generate and/or transmit an electronic signature request data object.

At step 308, the client device 351 receives user signing request information associated with electronically signing an electronic document data object. In some embodiments, the user signing request information is received by parsing a captured parseable image, for example captured at step 306, parsing encoded visual indicia from the parseable image, and decoding the encoded visual indicia. Alternatively or additionally, user signing request information may be received in response to manual user engagement by the user of the client device 351. For example, the user may engage with an electronic document signing interface, for example provided by a specially programmed service application (e.g., a web application accessed via a browser app, an executable app, or the like) to cause the client device 351 to receive the user signing request information.

At step 310, the client device 351 generates and/or transmits an electronic signature request data object to the signature management system 355, via the network provider 353. In some embodiments, the client device 351 transmits the electronic signature request data object to a signing request destination URL that the client device 351 identified from received user signing request information. In some embodiments, the signing request destination URL may be associated with a particular network device of the network provider 353, which is configured to forward the electronic signature request data object to the signature management system 355. In yet some embodiments, the signing request destination URL may be associated with a sub-device and/or sub-system of the signature management system 355. The electronic signature request data object may include some or all of the user signing request information, and/or may include data identified based on the received user signing request information (e.g., data received from the client device 351 and/or another device, system, or the like communicable with the client device 351 based on the received user signing request information).

The network provider 353 may include one or more network devices configured to perform one or more processes to identify device identification information for the client device associated with a received request, such as a request received and forwarded to the signature management system 355, or received by the signature management system 355 and forwarded to the network provider 353. In this regard, at step 312, the network provider 353 may detect or otherwise identify device identification information associated with the client device 351. In an example context, such as where the client device 351 is embodied by a mobile device, the device identification information may comprise a telephone number (in plain-text or hashed form) associated with the client device 351. The network provider 353, in such a context, may embody a carrier network associated with the client device 351, and may utilize one or more secure processes to identify the device identification information. In this context, for example, the network provider 353 may utilize a secure process for accessing the subscriber identity module (SIM) card, or virtual SIM or other technology, associated with the client device 351 to identify the device identification information. For example, in this context, the network provider 353 may utilize a process similar to the process used to identify the client device 351 for billing purposes. It should be appreciated that, in other contexts, the device identification information may comprise other information, including but not limited to an IP address, serial number, login information, and/or the like associated with the client device 351. Such other device identification information may be received through one or more other secure processes verifiable by the network provider 353, or another third-party entity via another third-party system, including but not limited to a header enrichment process, DAA process, login authentication process, and/or the like, such that the device identification information identified by the network provider 353 is considered trustworthy and associated with the client device 351.

At step 314, the network provider 353 may transmit the device identification information to the signature management system 355. In some embodiments, for example, the network provider 353 transmits the device identification information using a header enrichment process associated with the electronic signature request data object received from the client device 351, such that the signature management system 355 receives the electronic signature request data object with the device identification information “injected” into the transmission by the network provider 353. Additionally or alternatively, in some embodiments, the network provider 353 may transmit the device identification information separately from forwarding the electronic signature request data object, and may transmit the device identification information along with data for associating the device identification information with the forwarded electronic signature request data object.

At step 316, the signature management system 355 may associate device identification information, and/or some or all of the received electronic signature request data object, or some or all of the electronic signature request information of the electronic signature request data object, with a particular associated electronic document data object. In some embodiments, the electronic document data object is identified and associated with the received information based on electronic document device information provided in the electronic signature request information. In some embodiments, the electronic signature request data object is received with device identification information injected therein, for example via a header enrichment process, and the signature management system 355 may identify the injected device identification information and associate it with some or all of the electronic signature request information in the electronic signature request data object. For example, the signature management system 355 may associate the device identification information with at least the device identification information, electronic document data object identification information, and/or in some embodiments image data.

At step 318, the signature management system 355 may generate and/or store an electronic signature data object to the electronic signature blockchain 357. In some embodiments, the electronic signature data object may be stored to the electronic signature blockchain 357 alone, stored to a central database maintained by the signature management system 355, and/or both. The electronic signature data object may comprise the associated signing information set generated by the signature management system 355, for example generated at the association step 316. Alternatively, the associated signing information set may be used to generate the electronic signature data object, for example by using some or all of the associated signing information set to generate a cryptographic signature using one or more transformations, and associating the generated cryptographic signature with the electronic document data object and/or device identification information. In this regard, the electronic signature data object may be used to indicate that the user of the client device 351 has electronically signed the electronic document data object. It should be appreciated that, in some embodiments, the electronic signature data object may include additional and/or alternative data and/or metadata, including but not limited to a signature timestamp, a block hash for the block stored to the blockchain that includes the new electronic signature data object, an identification verification process identifier (e.g., identifying the particular process used to identify, detect, and/or verify the device identification information), captured image data associated with the electronic signature request data object, and/or the like.

At step 320, the signature management system 355 may generate and/or transmit an electronic signature response data object to the client device 351. The electronic signature response data object may indicate whether the electronic signature request data object was successfully authenticated and/or processed, and/or whether a corresponding electronic signature data object was successfully generated and/or added to the electronic signature blockchain 357. In some embodiments, the electronic signature response data object may embody a success message and/or indicator when the new electronic signature data object was successfully stored to the electronic signature blockchain 357. In some such circumstances, the electronic signature response data object may include the new electronic signature data object, and/or identification information for the electronic signature response data object. The electronic signature response data object may embody an error message and/or indicator when the signature management system 355 failed to authenticate device identification information and/or other authentication information received associated with the electronic signature request data object, or failed to store a new electronic signature data object to the electronic signature blockchain 357. The client device 351 may be configured to receive the electronic signature response data object, and perform one or more actions based on the electronic signature response data object and/or output one or more interfaces based on the electronic signature response data object (e.g., to render an interface indicating whether the electronic signature request data object was successfully processed).

In some embodiments, additional and/or alternative steps may be performed by embodiment systems described herein. In this regard, for example, the network provider 353 and/or signature management system 355 may perform one or more authentication steps not depicted in the illustrated data flow. Additionally or alternatively, in some embodiments, one or more of the depicted systems, devices, and/or the like, may be embodied by one or more sub-systems. For example, in some embodiments, the signature management system 355 may comprise an authentication server and a signature management server in communication with one another. Accordingly, it should be appreciated that the specific data flow illustrated with respect to FIG. 3 is an example and not to limit the scope or spirit of the disclosure herein.

### Exemplary Signature Management System Performed Processes

Having described an example data flow between components of a system in accordance with example embodiments of the present disclosure, example computer-implemented processes will now be described. It will be appreciated that the computer-implemented processes may be executed by one or more of the systems depicted with respect to the data flow of FIG. 3, and/or in a myriad of ways using various system configurations.

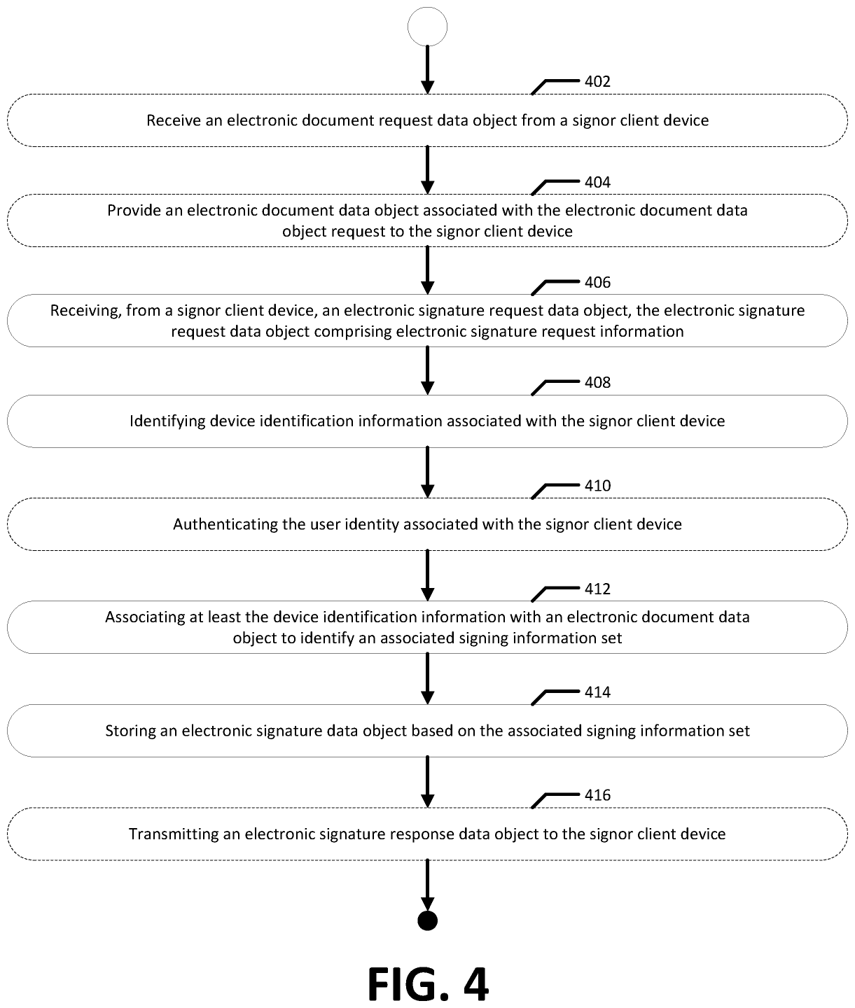

FIG. 4 illustrates an example process for frictionless electronic signature management in accordance with example embodiments of the present disclosure. The example process may provide a computer-implemented method to be performed by specially configured hardware and/or software, for example performed by the apparatus 200A. The illustrated operations may, in some embodiments, be performed by the apparatus 200A in response to a client device that received user signing request information, for example via manual input by a user of a signor client device or automatically received in response to capture and/or processing of a parseable image. For example, the signor client device may be associated with a user that desires to electronically sign an electronic document data object.

At optional block 402, the apparatus 200A includes means, such as authentication module 210A, signing management module 212A, input/output module 206A, communications module 208A, processor 202A, and/or the like, or a combination thereof, configured to receive an electronic document request data object from a signor client device. The electronic document request data object may include electronic document data object identification information associated with a selected electronic document data object. The selected electronic document data object may have been selected in response to user engagement by a user of the signor client device for accessing, for example to view and/or analyze the electronic document data object.

At optional block 404, the apparatus 200A includes means, such as authentication module 210A, signing management module 212A, input/output module 206A, communications module 208A, processor 202A, and/or the like, or a combination thereof, configured to provide an electronic document data object associated with the electronic document request data object to the signor client device. The apparatus 200A may first retrieve the electronic document data object, for example from one or more repositories controlled by and/or accessible to the apparatus 200A using information within the electronic document request data object. In some embodiments, the apparatus 200A may forward the electronic document request data object, or a portion thereof, to a third-party system that retrieves the electronic document data object and provides it back to the apparatus 200A for forwarding to the signor client device. The retrieved electronic document data object may be transmitted as part of a response transmission to the signor client device in response to the electronic document request data object. The apparatus 200A, by providing the electronic document data object, may cause the signor client device to render an electronic document signing interface that includes at least an interface component for submitting an electronic signature request data object associated with the provided electronic document data object.

At block 406, the apparatus 200A includes means, such as signing management module 212A, input/output module 206A, communications module 208A, processor 202A, and/or the like, or a combination thereof, configured to receive, from a signor client device, an electronic signature request data object. The electronic signature request data object may comprise electronic signature request information for use in processing the electronic signature request data object and/or generating and/or storing a corresponding electronic signature data object. The electronic signature request information may include, without limitation, at least an electronic document data object (or corresponding electronic document data object identification information). In some embodiments, the electronic signature request information additionally includes information specifically identifying a portion of the electronic document data object for signing via a new electronic signature data object. Additionally or alternatively, in some embodiments, the electronic signature request information includes information to authenticate the identity of the signor client device and/or a corresponding user, for example device location data and/or device user biometric data.

At block 408, the apparatus 200A includes means, such as signing management module 212A, processor 202A, and/or the like, or a combination thereof, configured to identify device identification information associated with the signor client device. In some embodiments, the device identification information is identified using a header enrichment process, a DAA process, a user login process, and/or the like. For example, in some embodiments, the apparatus 200A may identify the device identification information from the electronic signature request data object, for example where device identification information is injected into the electronic signature request data object forwarded to the apparatus 200A. In some such embodiments, the apparatus 200A communicates with a network device to identify the device identification information associated with the signor client device.

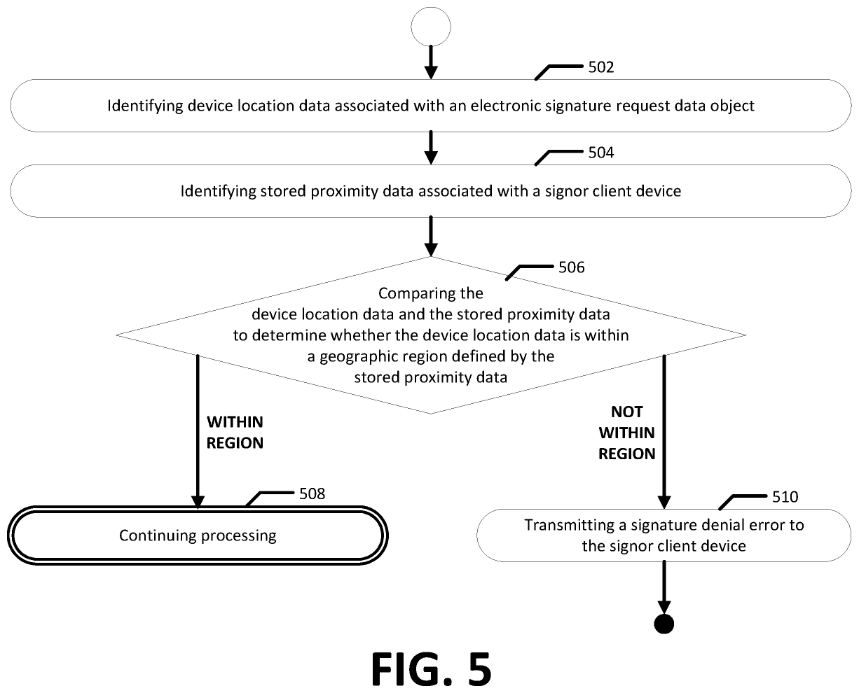

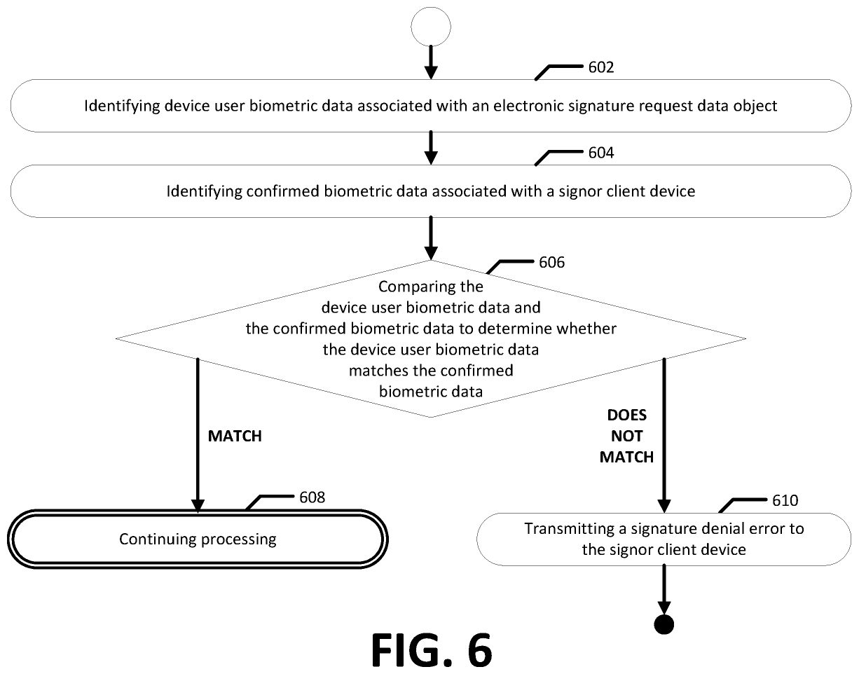

At optional block 410, the apparatus 200A includes means, such as authentication module 210A, signing management module 212A, input/output module 206A, communications module 208A, processor 202A, and/or the like, or a combination thereof, configured to authenticate the user identity associated with the signor client device. In some such embodiments, the apparatus 200A may be configured to authenticate the user identity using one or more authentication processes. For example, in some embodiments, the apparatus 200A may be configured to perform one or more of the processes described with respect to FIGS. 5-6. In this regard, the apparatus 200A may authenticate some or all of the received information, including device identification information and/or electronic signature request information from the received electronic signature request data object, to authenticate the user identity associated with the signor client device (e.g., authenticate the user is who they claim to be, authenticate the user has access to the signor client device, and/or authenticate the signor client device is the device it asserts to be). In some such embodiments, the apparatus 200A may be configured to retrieve stored information used to authenticate received and/or otherwise identified information. In some such embodiments, in a circumstance where the apparatus 200A fails to authenticate the user identity associated with the client device, the apparatus 200A may generate a signature denial error and provide the signature denial error to the signor client device as an electronic signature response data object, ending the flow.

Alternatively or additionally, in some embodiments, the apparatus 200A may communicate with an authentication server to authenticate the user identity associated with the signor client device. In some such embodiments, the apparatus 200A may be configured to transmit a portion of the electronic signature request information to the authentication server for processing. In an example context, the authentication server may be configured to perform one or more authentication processes and send a signal to the apparatus 200A based on the results of the authentication process(es). For example, the apparatus 200A may receive a termination signal from the authentication server in a circumstance where one or more authentication processes failed, and/or a continuation signal in a circumstance where all authentication processes succeeded. It should be appreciated that, in some embodiments, the apparatus 200A may suspend processing at block 410 until a signal is received from the authentication server.

At block 412, the apparatus 200A includes means, such as signing management module 212A, processor 202A, and/or the like, or a combination thereof, configured associate at least the device identification information with an electronic document data object to identify an associated signing information set. In some embodiments, additionally or alternatively, a portion of the electronic signature request data object (e.g., at least a portion of the electronic signature request information) is associated with the electronic document data object and device identification information to identify the associated signing information set. In this regard, in some embodiments, the electronic document data object is identified and/or retrieved based on a portion of the electronic signature request information, such as electronic document data object identification information. Alternatively or additionally, the electronic document data object may be identified based on other information included in the electronic signature request information, and/or a combination of the electronic signature request information and the device identification information.

In some embodiments, for example where the device identification information is injected into the electronic signature request data object via a header enrichment process, the device identification information may be associated with a particular subset of information from the associated electronic signature request data object to be used to generate a corresponding electronic signature data object. In other embodiments, the apparatus 200A may receive and/or identify, for example from a network device or third-party system, an identifier for associating device identification information with a specific electronic signature request data object and/or portion of electronic signature request information. For example, in some embodiments, the apparatus 200A generates and/or assigns a session or signing request identifier to the received electronic signature request data object, and communicates with a network device and/or third-party system to receive device identification information specifically associated with the session or signing request identifier, such that the session or signing request identifier may be used to associate the device identification information with a relevant portion of the electronic signature request information of the electronic signature request data object. In some embodiments, the resulting associated signing information set includes the device identification information and all other data required for generating an electronic signature data object that represents a user's signature of the electronic document data object.

At block 414, the apparatus 200A includes means, such as authentication module 210A, signing management module 212A, input/output module 206A, communications module 208A, processor 202A, and/or the like, or a combination thereof, configured to store an electronic signature data object based on the associated signing information set. The electronic signature data object may include all, or a portion of, the associated signing information set. In some embodiments, the apparatus 200A is configured to generate the electronic signature data object comprising at least the associated signing information set. For example, in some embodiments, the apparatus 200A generates an electronic signature data object that is stored associated with an electronic document data object and device identification information. Alternatively or additionally, the device identification information may be associated with a user data object, such that the electronic signature data object is associated with the user data object. In this regard, the device identification information and/or corresponding user data object may be used to link the electronic signature data object, further associated with a particular electronic document data object, with a user and/or device identity that is was verified and/or verifiable by a third-party entity. The electronic document data object may represent a physical document, or an electronically generated and maintained document and/or equivalent of a physical document. In some embodiments, the generated electronic signature data object may, additionally or alternatively, include one or more additional data fields, metadata (e.g., a signature timestamp), and/or the like.

In some embodiments, the electronic signature data object is stored to an electronic signature database maintained by the apparatus 200A. The apparatus 200A may, for example, store the electronic signature data object such that it is retrievable using at least electronic document data object identification information in the associated signing information set. In this regard, the apparatus 200A may be used to retrieve all signatures associated with a particular electronic document data object by querying the electronic signature database for electronic signature data objects based on the corresponding electronic document data object identification information.

Additionally or alternatively, in some embodiments, the electronic signature data object is stored to an electronic signature blockchain, To store the electronic signature data object in the electronic signature blockchain, the apparatus 200A may be configured to generate a storage identifier, such as a block hash for storing the new electronic signature data object, and append the new electronic signature data object to the electronic signature blockchain. It should be appreciated that, in some embodiments, the electronic signature blockchain comprises a private blockchain, hybrid blockchain, or modified public blockchain, or other implementation such that the apparatus 200A has permissions to add to and/or read from the electronic signature blockchain. The electronic signature blockchain may be readable only by the apparatus 200A, or indirectly by one or more client devices (e.g., through a request transmitted to the apparatus 200A) or directly by one or more client devices (e.g., in a distributed manner, for example). It should be appreciated that as a new electronic signature data object is appended to the electronic signature blockchain, a user via a client device and/or the apparatus 200A, or another system, may read from the electronic signature blockchain to determine if one or more electronic signature data object(s) have been provided associated with a particular electronic document data object.

Further, in some embodiments, the apparatus 200A may include means, such as signing management module 212A, input/output module 206A, communications module 208A, processor 202A, and/or a combination thereof, to initiate a transfer of electronically managed currency based on the newly generated electronic signature data object. In this regard, the electronically managed currency may be transferred from the device identification information (or an associated user account) to second device identification information (or a second associated user account) that is linked to the electronic document data object. For example, the electronic document data object may be linked to particular device identification information and/or a corresponding user account that submitted the electronic document data object, for example associated with a requestor who desires the signor to provide an electronic signature data object. In other embodiments, additionally or alternatively, one or more other actions may be initiated in response to the new electronic signature data object. One or more transfers of information and/or objects, performed electronically or physically, may be initiated upon generation and/or storage of the electronic signature data object.

At optional block 416, the apparatus 200A includes means, such as authentication module 210A, signing management module 212A, input/output module 206A, communications module 208A, processor 202A, and/or the like, or a combination thereof, configured to transmit an electronic signature response data object to the signor client device. The electronic signature response data object may comprise and/or embody an indication of whether all authentication processes were successfully completed and the new electronic signature data object was successfully generated and/or stored. For example, the electronic signature response data object may embody a signature denial error where one or more authentication processes failed, and may comprise an error message indicating the reason for such failure (e.g., the user's identity or client device identity could not be authenticated, failed to add the new electronic signature data object to the electronic signature blockchain, or the like). Alternatively, the electronic signature response data object may embody or comprise a signing success message upon successful storage of the new electronic signature data object.

FIG. 5 illustrates one example authentication process that may be used in some embodiments to facilitate frictionless electronic signature management. For example, in some embodiments, the process described with respect to FIG. 5 may embody a sub-process for performance as one authentication process in authentication of a user identity associated with a client device, for example at block 410 of the process depicted with respect to FIG. 4. It should be understood that, in some embodiments, the authentication process described with respect to FIG. 5 may be combined with one or more authentication processes with associated operations performed in any combination, order, and/or the like. The example process may provide a specific computer-implemented method to be performed by specially configured hardware and/or software, for example performed by the apparatus 200A.

At block 502, the apparatus 200A includes means, such as authentication module 210A, signing management module 212A, processor 202A, and/or the like, or a combination thereof, configured to identify device location data associated with an electronic signature request data object. The electronic signature request data object may have been previously received by the apparatus 200A, for example at an earlier block. In some embodiments, the apparatus 200A is configured to parse device location data transmitted as electronic signature request information within the electronic signature request data object. Additionally or alternatively, in some embodiments, the apparatus 200A may identify information from the electronic signature request data object, for example IP address information or other information identifying the client device associated with the electronic signature request data object (for example, the client device that originated the electronic signature request data object), to request and receive device location data from the client device. It should be appreciated that the device location data may be in any of a myriad of formats and embody a myriad of location types, for example, without limitation, a latitude and longitude coordinate, triangulation data from a network provider or another system associated with the client device, an address, a zip code, a region-identifier determined by the apparatus 200A based on one or more previous actions, and/or the like. The device location data, in some embodiments, may be stored by the client device, and retrieved for transmission to the apparatus 200A. Additionally or alternatively, in some embodiments, the apparatus 200A may detect, collect, and/or transmit the device location data in real-time, for example using location services hardware and/or software associated with the client device.

At block 504, the apparatus 200A includes means, such as authentication module 210A, signing management module 212A, processor 202A, and/or the like, or a combination thereof, configured to identify stored proximity data associated with a signor client device. The stored proximity data may include data representing one or more geographic areas such that the signor client device is authenticated if device location associated with the signor client device is within one of the geographic areas. For example, in some embodiments, the stored proximity data may include an approved location indicator and a radius, such that the stored proximity data represents a certain radius around the approved location. Alternatively or additionally, in some embodiments, the stored proximity data comprises a plurality of location boundary data objects, such that the stored proximity data represents an enclosed geographic area defined by the plurality of location boundary data objects.

In some embodiments, to identify the stored proximity data associated with the signor client device, the apparatus 200A is configured to retrieve the stored proximity data from a database or other repository. The stored proximity data may be retrieved based on the device identification information associated with the signor client device, for example where the stored proximity data is stored to a database associated with certain device identification information. In some embodiments, the apparatus 200A generates the stored proximity data associated with particular device identification information based on the device location data for one or more previously received request data objects, such as previous electronic signature request data object(s). In other embodiments, a user may configure and/or otherwise submit proximity data to be stored associated with the device identification information, or the like.

In some such embodiments, the apparatus 200A identifies stored proximity data using one or more database queries. For example, in some embodiments, the apparatus 200A is configured to query a proximity data database using identified device identification information and/or other information received and/or associated with an electronic signature request data object. The apparatus 200A may, in response to the query, receive result data including the stored proximity data associated with the device identification information, and thereby associated with the signor client device.

Alternatively or additionally, the apparatus 200A may communicate with one or more third-party systems to identify stored proximity data. The stored proximity data may be, for example, retrieved from a trusted third-party system using device identification information associated with the signor client device. Additionally or alternatively, the stored proximity data may be retrieved from a trusted third-party system using other information received from the signor client device, or a combination thereof. In this regard, to identify the stored proximity data, the apparatus 200A may transmit one or more requests for stored proximity data including such information to the third-party system(s) and receive the stored proximity data in response.

At determination block 506, the apparatus 200A includes means, such as authentication module 210A, signing management module 212A, processor 202A, and/or the like, or a combination thereof, configured to compare the device location data and the stored proximity data to determine whether the device location data is within a geographic region defined by the stored proximity data. In some embodiments, the apparatus 200A may utilize one or more application programming interfaces (APIs) to compare the device location data and the stored proximity data, wherein such one or more API(s) are configured to output the determination. Alternatively, in some embodiments, the apparatus 200A is configured to perform one or more range checks, for example a range check between the device location data and location data include in the stored proximity data, to output the determination as to whether the device location data satisfies a range threshold included in or associated with the geographic area defined by the stored proximity data (for example, the device location data is within the geographic area if less than the range threshold distance from a particular stored location). It should be appreciated that, in other embodiments, one or more additional and/or alternative algorithms may be used to determine whether the device location data is within the geographic region defined by the stored proximity data. In yet some embodiments, the apparatus 200A may communicate with a third-party system to perform blocks 504 and 506. In this regard, the apparatus 200A may transmit device location data associated with the electronic signature request data object to the third-party system, and receive, in response, data indicating whether the device location data is within the geographic region defined by the stored proximity data.

If, at block 506, the apparatus 200A determines the device location data is not within the geographic region defined by the stored proximity data, flow continues to block 510. At block 510, the apparatus 200A includes means, such as authentication module 210A, signing management module 212A, processor 202A, and/or the like, or a combination thereof, configured to transmit a signature denial error to the signor client device. The signature denial error may be embodied by, or include, an indication that the device location data is not within the geographic region defined by the stored proximity data. In some embodiments, the indication is embodied by a single number, letter, or other interpretable data value that is interpreted by the signor client device as associated with a particular failed authentication process (e.g., error number 1 corresponds to failed location authentication). Additionally or alternatively, a signature denial error may include an error message, for example indicating that the device is not located in a trusted location, or that user authentication has failed generally. The signor denial error may be transmitted to the signor client device as part of an electronic signature response data object transmitted in response to an earlier received electronic signature request data object.

Returning to block 506, if, at block 506, the apparatus 200A determines the device location data is within the geographic region defined by the stored proximity data, the apparatus 200A may continue processing the electronic signature request data object at block 508. In some embodiments, the apparatus 200A may proceed to one or more other authentication processes, for example represented in FIG. 6. Alternatively, in some embodiments, the apparatus 200A subsequently executes one or more other operations for processing an electronic signature request data object. For example, the apparatus 200A may continue performing one or more operations described above with respect to FIG. 4.

The determination may represent whether the signor client device, and thereby the associated user, is located within (or at) particular trusted location. For example, the stored proximity data may define a geographic region around a home address for a particular user associated with the client device, work address for the particular user associated with the client device, or the like. Alternatively or additionally, the stored proximity data may define a geographic region around a business and/or location where the signor client device is expected to be located (for example, where the signor client device is a business terminal located or associated with a particular business location). In this regard, such verification of device location data may improve system security by preventing processing of false requests transmitted by users accessing client devices in untrusted locations.

FIG. 6 illustrates yet another example authentication process that may be used in some embodiments to facilitate frictionless electronic signature management. For example, in some embodiments, the process described with respect to FIG. 6 may embody a sub-process for performance as one authentication process in authentication of a user identity associated with a client device, for example at block 410 of the process depicted with respect to FIG. 4. It should be understood that, in some embodiments, the authentication process described with respect to FIG. 6 may be combined with one or more authentication processes with associated operations performed in any combination, order, and/or the like. The example process may provide a specific computer-implemented method to be performed by specially configured hardware and/or software, for example performed by the apparatus 200A.

At block 602, the apparatus 200A includes means, such as authentication module 210A, signing management module 212A, processor 202A, and/or the like, or a combination thereof, configured to identify device user biometric data associated with an electronic signature request data object. In some embodiments, the device user biometric data is identified from the electronic signature request data object, which may have been previously received by the apparatus 200A (e.g., at an earlier block). In some embodiments, the apparatus 200A is configured to extract the device user biometric data from electronic signature request information within the electronic signature request data object. Additionally or alternatively, in some embodiments, the apparatus 200A may identify information from the electronic signature request data object, for example IP address information or other information identifying the client device associated with the electronic signature request data object, and use the other information to request and receive device user biometric data from the client device or another third-party system. It should be appreciated that the device user biometric data may be any of a myriad of biometrics associated with a user, for example and without limitation, fingerprint data, face scan data, iris scan data, walking gait data, passcode data, pass pattern data, voice data, and/or the like. Additionally or alternatively, in some embodiments, the apparatus 200A may capture, retrieve, and/or transmit the device user biometric data in real-time, for example using one or more hardware components associated with the client device (e.g., a fingerprint scanner, face scanner, microphone, and/or the like). In some embodiments, the device user biometric data may be encrypted, hashed, and/or otherwise transformed from a raw format such that user privacy associated with the device user biometric data is enhanced.

At block 604, the apparatus 200A includes means, such as authentication module 210A, signing management module 212A, processor 202A, and/or the like, or a combination thereof, configured to identify confirmed biometric data associated with signor client device. The confirmed biometric data may include data representing one or more biometric features associated with an authenticated user of the signor client device. The confirmed biometric data may be previously received by the client device, and forwarded to the apparatus 200A and/or otherwise provisioned by a user (e.g., at a previous block).

In some embodiments, to identify the confirmed biometric data associated with the signor client device, the apparatus 200A is configured to retrieve the confirmed biometric data from a database or other repository. The apparatus 200A may include one or more databases configured to store confirmed biometric data, for example a dedicated confirmed biometric database or a single database configured for storing multiple authentication data types (e.g., confirmed biometric data and stored proximity data). The confirmed biometric data may be retrieved based on the device identification information, for example where the confirmed biometric data is stored to a database associated with corresponding device identification information for the client device used to capture and/or transmit the confirmed biometric data. In some embodiments, the apparatus 200A stores confirmed biometric data associated with particular device identification information based on the device user biometric data for one or more previously received electronic signature request data objects, for example such that if a user submits more than a threshold number of electronic signature of requests associated with the same device user biometric data and same device identification information, such device user biometric data is stored as confirmed biometric information. In other embodiments, a user may configure and/or otherwise submit confirmed biometric data to be stored associated with the device identification information, or the like.

In some such embodiments, the apparatus 200A identifies confirmed biometric data using one or more database queries. For example, in some embodiments, the apparatus 200A is configured to query a confirmed biometric database using the identified device identification information and/or other information received and/or associated with an electronic signature request data object. The apparatus 200A may, in response to the query, receive result data including the confirmed biometric data associated with the device identification information, and thereby associated with the signor client device.

At determination block 606, the apparatus 200A includes means, such as authentication module 210A, signing management module 212A, processor 202A, and/or the like, or a combination thereof, configured to compare the device user biometric data and the confirmed biometric data to determine whether the device user biometric data matches the confirmed biometric data. In some such embodiments, the apparatus 200A is configured to perform a direct comparison between the device user biometric data and confirmed biometric data. In other embodiments, the apparatus 200A is configured to perform one or more un-encryption or other transformation operations on the device user biometric data and/or confirmed biometric data before comparing. Alternatively or additionally, in some embodiments, the apparatus 200A may implement one or more APIs for performing the comparison between the device user biometric data and the confirmed biometric data. The apparatus 200A may, in some embodiments, implement various comparison algorithms for biometric data of different types (e.g., a first comparison for fingerprint data, a second comparison for voice data, and/or the like).

If, at block 606, the apparatus 200A determines the device user biometric data does not match the confirmed biometric data, flow continues to block 610. At determination block 610, the apparatus 200A includes means, such as authentication module 210A, signing management module 212A, processor 202A, and/or the like, or a combination thereof, configured to transmit a signature denial error to the signor client device. The signature denial error may be embodied by, or include, an indication that the device user biometric data does not match the confirmed biometric data. In some embodiments, the indication is embodied by a single number, letter, or other interpretable data value that is interpreted by the signor client device as associated with a particular failed authentication process (e.g., error number 2 corresponds to failed biometric authentication). Additionally or alternatively, the signature denial error may include an error message, for example indicating that the particular biometric data captured did not match confirmed biometric data, or that user authentication has failed generally. The signature denial error may be transmitted to the client device as part of an electronic signature response data object transmitted in response to an earlier received electronic signature request data object.

Returning to block 606, if, at block 606, the apparatus 200A determines the device user biometric data matches the confirmed biometric data, the apparatus 200A may continue processing the electronic signature request data object at block 608. In some embodiments, the apparatus 200A may proceed to one or more other authentication processes, for example represented in FIG. 5. Alternatively, in some embodiments, the apparatus 200A subsequently executes one or more other operations for processing an electronic signature request data object. For example, the apparatus 200A may continue performing one or more operations described above with respect to FIG. 4.

The determination enables confirmation that the identity of the user transmitting the electronic signature request data object is an expected and/or authenticated user, and may be used to increase overall system security. In some embodiments, the overall system security is improved without explicit provisioning by the user. For example, the confirmed biometric data may be associated with an owner and/or authorized user of the signor client device, such that only such person(s) can submit one or more electronic signature request data object(s) for processing via that client device. In this regard, the determination may improve system security by preventing processing of false requests transmitted by users not authenticated to utilize a particular client device.

### Example Client Device Performed Processes

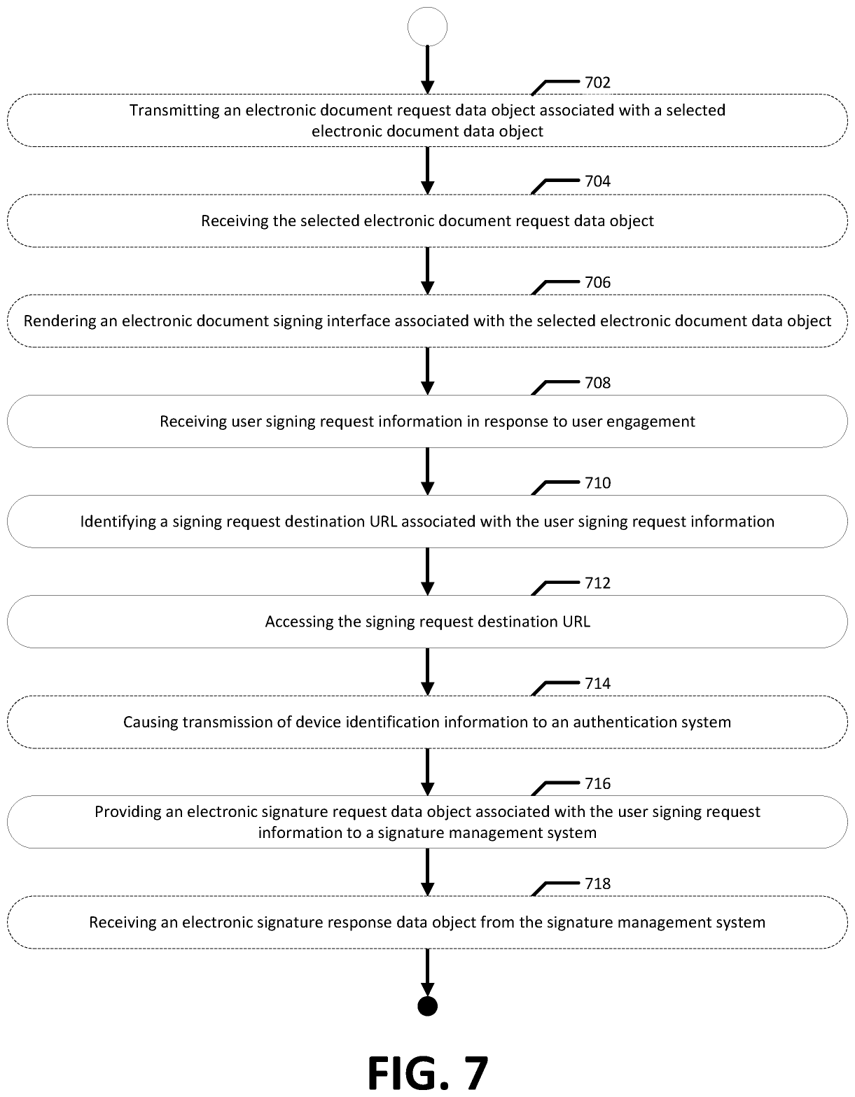

FIG. 7 illustrates an example process for frictionless electronic signature management in accordance with example embodiments of the present disclosure. The example process may provide a computer-implemented method to be performed by specially configured hardware and/or software, for example performed by the apparatus 200B. The illustrated operations, in some embodiments, may be performed by the apparatus 200B in response to user engagement associated with electronically signing an electronic document data object (which may or may not represent a physical contract), for example via generation and/or transmission of a corresponding electronic signature request data object. For example, the apparatus 200B may embody a specially configured client device for performing frictionless electronic signature management, specifically for initiating transmission of an electronic signature request data object to cause generation and storing of an electronic signature data object when the user (e.g., a signor) has accessed, analyzed, and/or reviewed all or a portion of a document (e.g., an electronically managed or physical contract, letter, or the like) and desires to provide an electronic signature of the document. It should be appreciated that, in some embodiments, the apparatus 200B is configured to provide some or all of the functionality described via a specially configured application executed by the apparatus 200B (e.g., a specially configured web application accessed through a browser application, or a native application, for example).

At optional block 702, the apparatus 200B includes means, such as capture management module 210B, signing request module 212B, input/output module 206B, communications module 208B, processor 202B, and/or the like, or a combination thereof, configured to transmit an electronic document request data object associated with a selected electronic document data object. In this regard, the apparatus 200B may be configured to provide an interface for selecting an electronic document data object associated with the apparatus 200B (e.g., linked via device identification information) or associated with the user of the apparatus 200B. In some embodiments, the apparatus 200B requests electronic document data object(s), or corresponding identification information, accessible to the apparatus 200B and/or associated with the apparatus 200B, where the request is transmitted to an signature management system and/or another third-party system for processing. The signature management system and/or third-party system, in response to the request, may identify device identification information associated with the apparatus 200B and utilize the device identification information to identify associated electronic document data object(s) for selection. In some other embodiments, the user may login (e.g., by providing authentication credentials) via the apparatus 200B to communicate with a third-party system and/or signature management system to retrieve electronic document data object(s) selectable by the user. The signature management system and/or third-party system may then provide the electronic document data object(s) and/or corresponding identification information as a response to cause the apparatus 200B to render an interface for selecting from the associated electronic document data object.

The user may indicate a selected electronic document data object via user engagement with the apparatus 200B. In some embodiments, for example, the apparatus 200B may provide an interface including an interface component for each electronic document data object, such that the user may engage the interface component associated with a particular electronic document data object to select that electronic document data object. The user may desire to access the selected electronic document data object, for example for viewing and/or electronic signing, via the apparatus 200B. In response to the selection, the apparatus 200B may generate and/or transmit the electronic document request data object to an signature management system and/or third-party system to cause retrieval and provision of the selected electronic document data object. The electronic document request data object may include at least electronic document data object identification information associated with the selected electronic document data object.

At optional block 704, the apparatus 200B includes means, such as capture management module 210B, signing request module 212B, input/output module 206B, communications module 208B, processor 202B, and/or the like, or a combination thereof, configured to receive the selected electronic document request data object. The selected electronic document request data object may be received in response to the transmitted electronic document request data object, for example the selected electronic document request data object may be included in an electronic document response data object. The apparatus 200B may be configured to render an interface comprising the selected electronic document request data object for analysis and/or viewing by a user.

At optional block 706, the apparatus 200B includes means, such as capture management module 210B, signing request module 212B, input/output module 206B, communications module 208B, processor 202B, and/or the like, or a combination thereof, configured to render an electronic document signing interface associated with the selected electronic document data object. The electronic document signing interface may include one or more interface components to initiate an electronic signing of the electronic document data object, or of a portion thereof. For example, the electronic document signing interface may include one or more buttons, links, and/or other interface components, each associated with a portion of the selected electronic document data object and configured to receive user engagement indicating a user desire to electronically sign the corresponding portion of the selected electronic document data object. The electronic document signing interface may be rendered in conjunction with one or more other interfaces. For example, the electronic document signing interface may be rendered together with an interface for viewing and/or analyzing the selected electronic document data object (e.g., above, overlapping in at least one portion of the interface, semi-transparent, and/or the like).

At block 708, the apparatus 200B includes means, such as capture management module 210B, signing request module 212B, processor 202B, input/output module 206B, communications module 208B, and/or the like, or a combination thereof, to receive user signing request information in response to user engagement. In some embodiments, the user engagement may embody manual input or engagement, for example engagement with an electronic document signing interface. For example, the user may, via the apparatus 200B, touch, speak, gesture or otherwise engage with the apparatus 200B to manually input user signing request information associated with electronically signing a document. In some such embodiments, the user may engage with a button or other pre-configured interface component to receive the user signing request information. In other embodiments, the user may provide one or more portions of the user signing request information (e.g., inputting electronic document data object identification information, inputting a signing request destination URL, and/or other information used for electronically signing a document). In some embodiments, the apparatus 200B renders an electronic document signing interface, and/or another interface, including interface components for providing free-text and/or other non-binary input(s).

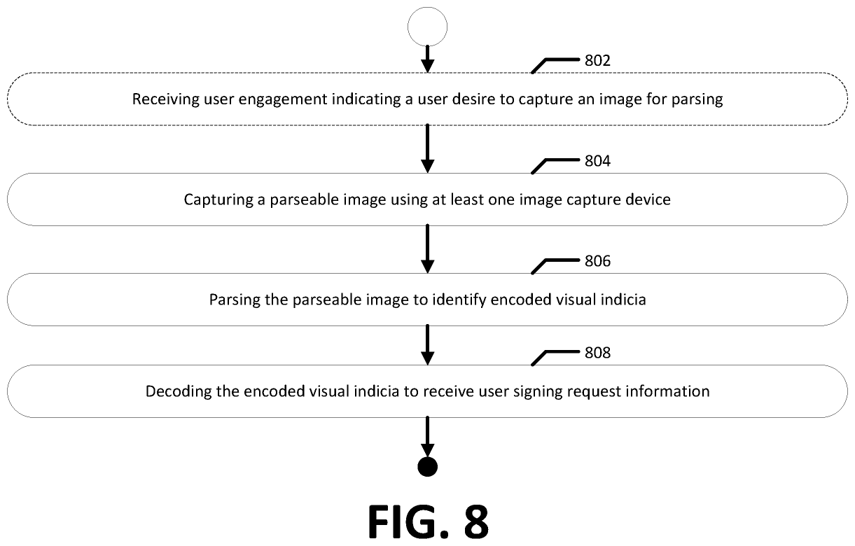

In some embodiments, the user engagement may be associated with receiving and/or capturing a parseable image, via the apparatus 200B, for processing to receive associated user signing request information. In this regard, for example, the user signing request information may be received as described below with respect to FIG. 8. It should be appreciated that, in some embodiments, a portion of the user signing request information may be manually input by a user, and a second portion of the user signing request information may be automatically identified, parsed, and/or decoded from a captured parseable image. For example, the captured parseable image may be parsed and/or decoded to receive an electronic document data object (or associated identification information). For example, in some embodiments, the apparatus 200B may parse a parseable image to identify encoded visual indicia that encodes the user signing request information, and decoding the encoded visual indicia to receive user signing request information.

At block 710, the apparatus 200B includes means, such as capture management module 210B, signing request module 212B, processor 202B, and/or the like, or a combination thereof, to identify a signing request destination URL associated with the user signing request information. The signing request destination URL may represent an endpoint in the network system for which information, such as a generated electronic signature request data object, should be transmitted to for processing. For example, in some embodiments, the apparatus 200B may parse the signing request destination URL from the user signing request information. In this regard, for example, a signing request destination URL may be customized based on the electronic document data object associated with or otherwise identified within the user signing request information. Alternatively, in some embodiments, the apparatus 200B may be configured to identify a pre-determined signing request destination URL. In some such embodiments, the apparatus 200B may append and/or otherwise utilize the user signing request information, or a portion thereof, to differentiate between electronically signing different electronic document data objects when transmitting information to the pre-determined signing request destination URL. For example, in some embodiments, all transmissions of generated electronic signature request data object(s) are transmitted to the same pre-determined signing request destination URL, and the endpoint located at the pre-determined signing request destination URL parses and/or extracts information from the transmitted electronic signature request data object to properly process the request.

At block 712, the apparatus 200B includes means, such as signing request module 212B, processor 202B, input/output module 206B, communications module 208B, and/or the like, or a combination thereof, configured to access the signing request destination URL. In some such embodiments, the apparatus 200B may access the signing request destination URL in response to receiving the user signing request information. In some embodiments, the signing request destination URL is accessed via user engagement by the user of the apparatus 200B. For example, the apparatus 200B may receive user engagement for accessing the signing request destination URL and generating and/or transmitting corresponding information for processing. In some such embodiments, the signing request destination URL may embody an endpoint at a network device, which may be configured to forward the transmitted information to another device, such as a signature management system. In some other embodiments, the signing request destination URL may embody an endpoint at a device, subsystem, or the like within a signature management system.

At optional block 714, the apparatus 200B includes means, such as capture management module 210B, signing request module 212B, processor 202B, communications module 208B, and/or the like, or a combination thereof, to cause transmission of device identification information to an authentication system. In some embodiments, to cause transmission of the device identification information to the authentication system, the apparatus 200B is configured to generate and/or transmit an electronic signature request data object, and/or other information, over a communications network to a device associated with the signing request destination URL. In some such embodiments, the device identification information may be injected, by a network device of the communications network for example, into the transmission from the apparatus 200B, for example using a header enrichment process. In a particular example, the signing request destination URL may represent a particular endpoint network device of a carrier network associated with the apparatus 200B embodying a mobile device, such that the network device is configured to inject the mobile phone number associated with the mobile device (in plaintext, hashed, or encrypted format) into the transmission before forwarding it to the authentication system.

It should be appreciated that, in some embodiments, the authentication system is a sub-system of a signature management system. Alternatively, in other embodiments, the authentication system is separate from the signature management system, and is communicable with the signature management system to perform one or more authentication process(es) and transmit one or more signals indicating the results of the authentication processes. In this regard, the authentication system may be configured to receive device identification information and/or other information, such as information and/or data used in one or more authentication processes, directly from the apparatus 200B over a communications network, and authenticate such information using the one or more authentication processes. In yet other embodiments, the authentication system may receive the device identification information, and/or other transmitted information, indirectly via the signature management system. For example, in some embodiments, the apparatus 200B may cause transmission of device identification information to the signature management system for processing and/or forwarding to the authentication system. In other embodiments, the signature management system, for example embodied by the apparatus 200A, comprises and/or embodies the authentication system, such that no forwarding is required.

At block 716, the apparatus 200B includes means, such as signing request module 212B, processor 202B, communications module 208B, and/or the like, or a combination thereof, to provide an electronic signature request data object associated with the user signing request information to a signature management system. For example, in some embodiments, the apparatus 200B is configured to configure and/or generate the electronic signature request data object based on the user signing request information. For example, the electronic signature request data object may include at least electronic document data object identification information included in the received user signing request information. In yet other embodiments, the apparatus 200B may include additional and/or alternative data and/or information in the electronic signature request data object that may be included in and/or used by one or more external systems, such as an signature management system to create and/or store a corresponding electronic signature data object.

In some embodiments, the electronic signature request data object is provided to the signature management system over a communications network. For example, the electronic signature request data object may be transmitted over the communications network to a particular device, system, and/or the like, associated with the signing request destination URL. In some such embodiments, the signing request destination URL represents an endpoint at a network device of the communications network, where the network device is configured to forward the electronic signature request data object to the signature management system (for example, after performing a header enrichment process to inject device identification information into the transmission). In other embodiments, the signing request destination URL represents an endpoint at the signature management system, or a sub-system thereof, such that no forwarding is required.

In response to receiving the electronic signature request data object, the signature management system may process the electronic signature request data object. For example, in some embodiments, the signature management system alone or in conjunction with an authentication system may perform one or more authentication processes based on information associated with and/or provided in the electronic signature request data object. Additionally or alternatively, the signature management system may process the electronic signature request data object to generate and/or store a new electronic signature data object associated with an electronic document data object identified by the electronic signature request data object. For example, the signature management system may generate and store a new electronic signature data object to an electronic signature blockchain.

At optional block 718, the apparatus 200B includes means, such as signing request module 212B, processor 202B, input/output module 206B, communications module 208B, and/or the like, or a combination thereof, to receive an electronic signature response data object from the signature management system. In an example context, the electronic signature response data object may comprise a signature denial error where one or more authentication processes performed by the signature management system and/or an associated authentication system failed. In another example context, the electronic signature response data object may indicate that processing the electronic signature request data object was successfully performed. For example, the electronic signature response data object may include information identifying the newly stored electronic signature data object (e.g., a block hash and/or other identifier).

In some such embodiments, such means may further be configured to perform one or more actions based on the received electronic signature response data object. For example, in some embodiments, the apparatus 200B may output one or more associated interfaces for rendering. Such interfaces may be configured to display, to a user for example, whether the electronic signature request data object was successfully processed based on the electronic signature response data object. Alternatively, the apparatus 200B may transmit one or more notification messages in response to an electronic signature response data object embodying or including a signature denial error. Such notification messages may be transmitted to one or more client devices indicating that a fraudulent electronic signature attempt was initiated, and in some embodiments may provide device identification information or the like for use in identifying the unauthenticated request initiator or corresponding client device.

FIG. 8 illustrates one example process for receiving user signing request information that may be used in some embodiments to facilitate frictionless electronic signature management. For example, in some embodiments, the process described with respect to FIG. 8 may embody a sub-process for facilitating frictionless electronic signature management, for example at block 804 of the process depicted with respect to FIG. 8. It should be understood that, in some embodiments, the process described with respect to FIG. 8 may be combined with other processes with associated operations performed in any combination, order, and/or the like. The example process may provide a specific computer-implemented method to be performed by specially configured hardware and/or software, for example performed by the apparatus 200B in conjunction with one or more other processes.

At optional block 802, the apparatus 200B includes means, such as capture management module 210B, signing request module 212B, input/output module 206B, communications module 208B, processor 202B, and/or the like, or a combination thereof, to receive user engagement indicating a user desire to capture an image for parsing. In this regard, the user engagement may be associated with activating one or more components of the apparatus 200B, such as one or more image capture devices, cameras, sensors, and/or the like. It should be appreciated that any of a myriad of user engagement types may be received. For example, a user may perform a tap, click, button press, key press, gesture, voice command, eye command, motion control, and/or the like specifically associated with capturing an image. In yet some embodiments, the apparatus 200B may detect a parseable image upon movement of the apparatus 200B into a particular position by the user (e.g., positioned such that an image capture device is facing the encoded visual indicia printed on a document). In some such contexts, the movement functions as the user engagement and the apparatus 200B automatically captures the parseable image in response to the movement without subsequent user engagement. In some embodiments, the user engagement may be received by a specially executed service application executed via the apparatus 200B.

At block 804, the apparatus 200B includes means, such as capture management module 210B, signing request module 212B, input/output module 206B, communications module 208B, processor 202B, and/or the like, or a combination thereof, to capture a parseable image using at least one image capture device. The apparatus 200B may capture the parseable image in response to the received user input. In some embodiments, the at least one capture device comprises at least one camera associated with the apparatus 200B. The parseable image may be captured by the camera(s) for further processing by the apparatus 200B.

The parseable image may include encoded visual indicia that is detectable, parseable, and/or decodable by the apparatus 200B to receive associated user signing request information. For example, in some embodiments, the parseable image comprises a QR code, barcode, parseable text, encoded image, and/or the like, that encodes some or all of the user signing request information. In some embodiments, the parseable image includes one or more sub-parseable images or sub-encoded visual indicias, for example a QR code and a barcode. In some such embodiments, the sub-parseable images and/or sub-encoded visual indicias may each include a portion of information that, when combined, forms the user signing request information.

The captured parseable image may include encoded visual indicia printed, imprinted, etched into, and/or otherwise physically presented on a particular document associated with a corresponding electronic document data object. Alternatively or additionally, the parseable image may include encoded visual indicia provided associated with a document, for example on an associated webpage or other material. In some such embodiments, the parseable image may be captured when the user desires to electronically sign the associated document.

At block 806, the apparatus 200B includes means, such as capture management module 210B, signing request module 212B, processor 202B, and/or the like, or a combination thereof, configured to parse the parseable image to identify encoded visual indicia. In some such embodiments, the apparatus 200B is configured to parse the parseable image using one or more parsing methodologies. For example, the encoded visual indicia may be designed to be detected from within the captured parseable image and parsed therefrom. It should be appreciated that, in some embodiments, the encoded visual indicia is parsed automatically by the apparatus 200B, or using at least one manual step by the user of the apparatus 200B (for example, to isolate the encoded visual indicia from the parseable image). Non-limiting examples of encoded visual indicia include a QR code, barcode, encoded pattern, color-coded pattern, and/or the like.

At block 808, the apparatus 200B includes means, such as capture management module 210B, signing request module 212B, processor 202B, and/or the like, or a combination thereof, configured to decode the encoded visual indicia to receive user signing request information. For example, the user signing request information may include data used for generating and/or transmitting an electronic signature data object associated with electronically signing a particular electronic document data object. The user signing request information may include, for example and without limitation, at least an electronic document data object (or corresponding electronic document data object identification information) associated with an electronic document data object corresponding to a particular document. Additionally or alternatively, in some embodiments, the user signing request information may include a signing request destination URL. Additionally or alternatively, in some embodiments, the user signing request information may include additional information for use by a signature management system to process a corresponding electronic signature request data object.

In some embodiments, the user signing request information decoded from the encoded visual indicia parsed from the parseable image may be encrypted. In some such embodiments, the apparatus 200B may be configured to decrypt the encrypted user signing request information. For example, the apparatus 200B may be configured to apply the encrypted user signing request information to one or more decryption algorithms. In yet other embodiments, the apparatus 200B may leave the user signing request information in an encrypted format for transmission to the signature management system and/or authentication system for decryption and/or comparison.

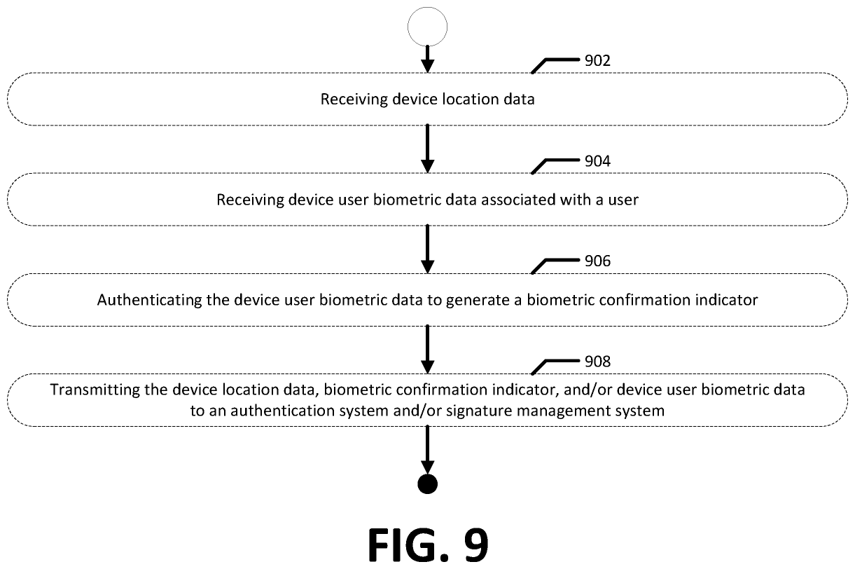

FIG. 9 illustrates one example process for user authentication at a client device that may be included, in some embodiments, to facilitate frictionless electronic signature management. For example, in some embodiments, the process described with respect to FIG. 9 may embody a sub-process for facilitating frictionless electronic signature management, for example as additional or alternative operations to the process depicted with respect to FIG. 9. It should be understood that, in some embodiments, the process described with respect to FIG. 9 may be combined with other processes with associated operations performed in any combination, order, and/or the like. The example process may provide a specific computer-implemented method to be performed by specially configured hardware and/or software, for example performed by the apparatus 200B in conjunction with one or more other processes.

At optional block 902, the apparatus 200B includes means, such as the capture management module 210B, signing request module 212B, input/output module 206B, communications module 208B, processor 202B, and/or the like, or a combination thereof, to receive device location data. In some embodiments, such means include location services hardware (e.g., GPS, one or more triangulation units, or the like) for receiving the device location data. In other embodiments, the device location data may be received in response to user input, for example from a user of the apparatus 200B. Additionally or alternatively, in some embodiments, the apparatus 200B may receive some or all of the device location data by retrieving the device location data from a database managed by the apparatus 200B. It should be appreciated that the device location data may be received in a variety of formats (e.g., a GPS coordinate, latitude and longitude coordinate, a region designation, address, zip code, and/or the like). The device location data may indicate a current location of the user and/or apparatus 200B.

At optional block 904, the apparatus 200B includes means, such as the capture management module 210B, signing request module 212B, input/output module 206B, communications module 208B, processor 202B, and/or the like, or a combination thereof, to receive device user biometric data associated with the user. In some such embodiments, such means include one or more scanning and/or detection components, hardware, circuitry, and/or the like, each configured for receiving one or more type of biometric data. For example, the apparatus 200B may include a fingerprint scanner, face scanner, iris scanner, walking gait scanner, microphone, and/or the like, or a combination thereof, to receive the device user biometric data. The user of the apparatus 200B may engage with one or more of these components to prompt receiving of the device user biometric data. Alternatively or additionally, in some embodiments, the apparatus 200B may receive some or all of the device user biometric data by retrieving it from a database managed by the apparatus 200B.

At optional block 906, the apparatus 200B includes means, such as the signing request module 212B, processor 202B, and/or the like, or a combination thereof, to authenticate the device user biometric data to generate a biometric confirmation indicator. For example, the apparatus 200B may compare the device user biometric data received to one or more instances of stored confirm biometric data. The stored confirmed biometric data may have been provisioned and/or configured from the user at an earlier time, for example during installation of a specially configured service app and/or during setup and/or configuration of the apparatus 200B. In some embodiments, the apparatus 200B may leverage one or more APIs to perform the authentication of the device user biometric data. For example, the apparatus 200B may access one or more operating system APIs provided by the operating system of the apparatus 200B to securely authenticate the device user biometric data. The biometric confirmation indicator may represent the results of the authentication. For example, the biometric confirmation indicator may embody a first value indicating the authentication failed (e.g., a false Boolean data value, a 0 integer value, a string indicating failed, and/or the like), or a second value indicating the authentication succeeded (e.g., a true Boolean data value, a 1 integer value, a string indicating success, and/or the like).

At optional block 908, the apparatus 200B includes means, such as the capture management module 210B, signing request module 212B, input/output module 206B, communications module 208B, processor 202B, and/or the like, or a combination thereof, to transmit the device location data, biometric confirmation indicator, and/or device user biometric data to an authentication system and/or a signature management system. In some embodiments, either the device user biometric data or the biometric confirmation indicator may be transmitted, but not both. The apparatus 200B may include each portion of data in an electronic signature request data object that is transmitted to the authentication system and/or signature management system, either directly or indirectly. The transmitted device location data, biometric confirmation indicator, and/or device user biometric data may be used to perform one or more authentication processes.

In some embodiments, for example where the operations depicted with respect to FIG. 9 are a sub-process, processing of another line of operations may continue after block 908. For example, in embodiments where the operations depicted with respect to FIG. 9 are additionally and/or alternatively included with one or more of the operations described with respect to FIG. 7, one or more operations of FIG. 7 may continue upon completion of operation 908. Alternatively, in some embodiments, the authentication system and/or signature management system may proceed with analyzing data transmitted to it, for example an electronic signature request data object including the device location data, biometric confirmation indicator, and/or device user biometric data, and the flow may end after block 908.

### CONCLUSION

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the disclosure, and the inventions covered by the appended claims, are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for frictionless electronic signature management, the apparatus comprising at least one processor and at least one memory, the at least one memory having computer-coded instructions thereon, the computer-coded instructions configured to, in execution with the at least one processor, configure the apparatus to:
receive, from a signor client device, an electronic signature request data object comprising electronic signature request information;
identify device identification information associated with the signor client device;
associate at least a portion of the device identification information with at least an electronic document data object to identify an associated signing information set; and
store, to an electronic signature storage, an electronic signature data object based on the associated signing information set.

2. The apparatus of claim 1, wherein the device identification information associated with the signor client device is identified, using a header enrichment process, from a network device associated with a trusted network provider.

3. The apparatus of claim 1, wherein the apparatus is further configured to:
receive an electronic document request data object from the signor client device; and
provide an electronic document data object associated with the electronic document request data object to the signor client device,
wherein the apparatus is configured to receive the electronic signature request data object in response to user engagement with the electronic document data object on the signor client device.

4. The apparatus of claim 1, wherein the electronic signature request data object further comprises device location data associated with the signor client device, and wherein the apparatus is configured to:
identify proximity data associated with the signor client device; and
compare the device location data and the proximity data to determine the device location data is within a geographic region defined by the proximity data.

5. The apparatus of claim 1, wherein the electronic signature request data object further comprises device user biometric data, and wherein the apparatus is configured to:
identify confirmed biometric data associated with the signor client device; and
compare the device user biometric data and the confirmed biometric data to determine the device user biometric data matches the confirmed biometric data.

6. The apparatus of claim 1, wherein the electronic signature request data object further comprises device location data associated with the signor client device, and wherein the apparatus is configured to:
identify proximity data associated with the signor client device;
compare the device location data and the proximity data to determine the device location data is not within a geographic region defined by the proximity data; and
transmit a signature denial error to the signor client device in response to the determination.

7. The apparatus of claim 1, wherein the electronic signature request data object further comprises device user biometric data, and wherein the apparatus is configured to:
identify confirmed biometric data associated with the signor client device;
compare the device user biometric data and the confirmed biometric data determine the device user biometric data does not match the confirmed biometric data; and
transmit a signature denial error to the signor client device in response to the determination.

8. The apparatus of claim 1 further configured to:
receive, from an authentication service, a signing continuation signal in response to authentication, by the authentications service, of the device user identity associated with the signor client device.

9. The apparatus of claim 1, wherein the electronic signature storage comprises an electronic signature blockchain.

10. A computer-implemented method for frictionless electronic signature management, the method comprising:
receiving, from a signor client device, an electronic signature request data object comprising electronic signature request information;
identifying device identification information associated with the signor client device;
associating at least a portion of the device identification information with at least an electronic document data object to identify an associated signing information set; and
storing, to an electronic signature storage, an electronic signature data object based on the associated signing information set.

11. The method of claim 10, wherein the device identification information associated with the signor client device is identified, using a header enrichment process, from a network device associated with a trusted network provider.

12. The method of claim 10, the method further comprising:
receiving an electronic document request data object from the signor client device; and
providing an electronic document data object associated with the electronic document request data object to the signor client device,
wherein the electronic signature request data object is received in response to user engagement with the electronic document data object via the signor client device.

13. The method of claim 10, wherein the electronic signature request data object further comprises device location data associated with the signor client device, and the method further comprising:
identifying proximity data associated with the signor client device; and
comparing the device location data and the proximity data for determining the device location data is within a geographic region defined by the proximity data.

14. The method of claim 10, wherein the electronic signature request data object further comprises device user biometric data, and the method further comprising:
identifying confirmed biometric data associated with the signor client device; and
comparing the device user biometric data and the confirmed biometric data to determine the device user biometric data matches the confirmed biometric data.

15. The method of claim 10, wherein the electronic signature request data object further comprises device location data associated with the signor client device, and the method further comprising:
identifying proximity data associated with the signor client device;
comparing the device location data and the proximity data to determine the device location data is not within a geographic region defined by the proximity data; and
transmitting a signature denial error to the signor client device in response to the determination.

16. The method of claim 10, wherein the electronic signature request data object further comprises device user biometric data, and the method further comprising:
identifying confirmed biometric data associated with the signor client device;
comparing the device user biometric data and the confirmed biometric data determine the device user biometric data does not match the confirmed biometric data; and
transmitting a signature denial error to the signor client device in response to the determination.

17. The method of claim 10, the method further comprising:
receiving, from an authentication service, a signing continuation signal in response to authentication, by the authentications service, of the device user identity associated with the signor client device.

18. The method of claim 10, wherein the electronic signature storage comprises an electronic signature blockchain.

19. A computer program product for frictionless electronic signature management, the computer program product comprising a non-transitory computer readable storage medium having computer program instructions stored thereon, the computer program instructions, when executed by a processor, configured for:
receiving, from a signor client device, an electronic signature request data object comprising electronic signature request information;
identifying device identification information associated with the signor client device;
associating at least a portion of the device identification information with at least an electronic document data object to identify an associated signing information set; and
storing, to an electronic signature storage, an electronic signature data object based on the associated signing information set.

20. (canceled)

21. The computer program product of claim 19, the computer program instructions further configured for:
receiving an electronic document request data object from the signor client device; and
providing an electronic document data object associated with the electronic document request data object to the signor client device,
wherein the electronic signature request data object is received in response to user engagement with the electronic document data object via the signor client device.

22-51. (canceled)
